(19) United States
(12) Patent Application Publication
(10) Pub. No.: US 2026/0018680 A1
(43) Pub. Date: Jan. 15, 2026

(54) ELECTROCHEMICAL CELLS HAVING INTEGRATED SEPARATORS

(71) Applicant: EnPower, Inc., Indianapolis, IN (US)

(72) Inventors: Matthew DURANT, Scottsdale, AZ (US); Andres VILLA PULIDO, Indianapolis, IN (US); Adrian YAO, Palo Alto, CA (US)

(21) Appl. No.: 19/269,994

(22) Filed: Jul. 15, 2025

Related U.S. Application Data
(60) Provisional application No. 63/671,596, filed on Jul. 15, 2024.

(51) Int. Cl. H01M 10/0587; H01M 4/04; H01M 50/403; H01M 50/434; H01M 50/443

(52) U.S. Cl. CPC H01M 10/0587; H01M 4/0404; H01M 4/0435; H01M 50/403; H01M 50/434; H01M 50/443

(57) ABSTRACT

In some examples, electrochemical cells including integrated ceramic separators include integrated separators comprising a mixture of nitrides and ceramic particles. In some examples, electrochemical cells including integrated ceramic separators include a protective strip of polymer and/or wax applied to an interface between a cathode tab and the cathode. In some examples, a method of manufacturing electrochemical cells including integrated ceramic separators includes simultaneous coating of an integrated ceramic separator onto an anode and a cathode and simultaneous lamination of the anode and cathode with the integrated ceramic separator. In some examples, a method of manufacturing electrochemical cells including integrated ceramic separators includes forming a unified separator by bonding a first integrated ceramic separator to a second integrated ceramic separator utilizing a plasticizing solvent to soften binders disposed at an interface between the separators and/or crosslinking.

### CROSS-REFERENCES

The following applications and materials are incorporated herein by reference, in their entireties, for all purposes: U.S. Provisional Patent Application Ser. No. 63/671,596, filed Jul. 15, 2024.

### FIELD

This disclosure relates to systems and methods for electrochemical cells. More specifically, the disclosed embodiments relate to electrochemical cells having integrated separators.

### INTRODUCTION

Environmentally friendly sources of energy have become increasingly critical, as fossil fuel-dependency becomes less desirable. Most non-fossil fuel energy sources, such as solar power, wind, and the like, require some sort of energy storage component to maximize usefulness. Accordingly, battery technology has become an important aspect of the future of energy production and distribution. Most pertinent to the present disclosure, the demand for secondary (i.e., rechargeable) batteries has increased. Various combinations of electrode materials and electrolytes are used in these types of batteries, such as lead acid, nickel cadmium (NiCad), nickel metal hydride (NiMH), nickel manganese cobalt oxide (NMC), nickel cobalt aluminum oxide (NCA), lithium ion (Li-ion), and lithium-ion polymer (Li-ion polymer).

### SUMMARY

The present disclosure provides systems, apparatuses, and methods relating to electrochemical cells having integrated separators.

In some examples, a method of manufacturing an electrochemical cell includes: manufacturing a first electrode, wherein manufacturing the first electrode includes: layering a first active material layer onto a first current collector substrate, the first active material layer including a plurality of first active material particles; and layering a first integrated separator layer onto the first active material layer, the first integrated separator layer including a plurality of first ceramic separator particles; and manufacturing a second electrode, wherein manufacturing the second electrode includes: layering a second active material layer onto a second current collector substrate, the second active material layer including a plurality of second active material particles; and layering a second integrated separator layer onto the second active material layer, the second integrated separator layer including a plurality of second ceramic separator particles; and placing the first electrode onto the second electrode such that the first integrated separator layer is adjacent to the second integrated separator layer.

In some examples, a method of manufacturing an electrochemical cell includes: placing a first electrode including a first integrated separator layer onto a second electrode including a second integrated separator layer, such that the first integrated separator layer is adjacent to the second integrated separator layer; and calendering the first electrode and the second electrode as a cell stack, thereby causing the first integrated separator and the second integrated separator to merge and become indistinguishable from each other.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram depicting an illustrative electrochemical cell in accordance with aspects of the present disclosure.

FIG. 2 is a schematic diagram depicting an illustrative electrode including an integrated separator in accordance with aspects of the present disclosure.

FIG. 3 is a chart depicting the porosity of an integrated separator as a function of a percentage of hexagonal-boron nitride.

FIG. 4 is a chart depicting the density and porosity of an integrated separator as a function of a ratio between hexagonal-boron nitride content and alumina content.

FIG. 5 is a sectional view of an interlocking region included within the illustrative electrode of FIG. 2.

FIG. 6 is a sectional view of an illustrative multilayered electrode including an integrated separator.

FIG. 7 is a sectional view of an illustrative electrochemical cell including an anode having an integrated separator, a cathode having an integrated separator, and a polyolefin separator disposed between the anode and the cathode.

FIG. 8 is a sectional view of an illustrative electrochemical cell having an anode, a cathode having an integrated separator, and a polyolefin separator disposed between the anode and the cathode.

FIG. 9 is a sectional view of an illustrative electrochemical cell having an anode including an integrated separator, a cathode, and a polyolefin separator disposed between the anode and the cathode.

FIG. 10 is a sectional view of an illustrative electrochemical cell having an anode including an integrated separator and a cathode having an integrated ceramic separator.

FIG. 11 is a flow chart depicting steps of an illustrative method for manufacturing an electrode including an integrated separator according to the present teachings.

FIG. 12 is a sectional view of an illustrative electrode undergoing a calendering process in accordance with aspects of the present disclosure.

FIG. 13 is a schematic diagram of a first illustrative manufacturing system suitable for manufacturing electrodes and electrochemical cells of the present disclosure.

FIG. 14 is a schematic diagram of a second illustrative manufacturing system suitable for manufacturing electrodes and electrochemical cells of the present disclosure.

FIG. 15 is a flow chart depicting steps of an illustrative method for insulating a cathode in accordance with the present teachings.

FIG. 16 depicts an example of an electrode material composite on a substrate web, prior to blanking.

FIG. 17 depicts an illustrative electrochemical cell, assembled from punched electrodes.

FIG. 18 depicts an illustrative cathode including a protective strip applied to a junction between a cathode body and a cathode tab.

FIG. 19 is a schematic diagram of an illustrative stacked cell format with a protective strip applied to cathode layers, in accordance with aspects of the present disclosure.

FIG. 20 is a flow chart depicting steps of an illustrative method for manufacturing an electrochemical cell including an integrated separator according to the present teachings.

FIG. 21 is a schematic diagram depicting an illustrative manufacturing system suitable for use in the method of FIG. 20.

### DETAILED DESCRIPTION

Various aspects and examples of electrochemical cells having integrated separators, as well as related systems and methods, are described below and illustrated in the associated drawings. Unless otherwise specified, an electrochemical cell in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Elongate” or “elongated” refers to an object or aperture that has a length greater than its own width, although the width need not be uniform. For example, an elongate slot may be elliptical or stadium-shaped, and an elongate candlestick may have a height greater than its tapering diameter. As a negative example, a circular aperture would not be considered an elongate aperture.

“Coupled” means connected, either permanently or releasably, whether directly or indirectly through intervening components.

“Resilient” describes a material or structure configured to respond to normal operating loads (e.g., when compressed) by deforming elastically and returning to an original shape or position when unloaded.

“Rigid” describes a material or structure configured to be stiff, non-deformable, or substantially lacking in flexibility under normal operating conditions.

“Elastic” describes a material or structure configured to spontaneously resume its former shape after being stretched or expanded.

Directional terms such as “up,” “down,” “vertical,” “horizontal,” and the like should be understood in the context of the particular object in question. For example, an object may be oriented around defined X, Y, and Z axes. In those examples, the X-Y plane will define horizontal, with up being defined as the positive Z direction and down being defined as the negative Z direction.

“NCA” means Lithium Nickel Cobalt Aluminum Oxide (LiNiCoAlO₂).

“NMC” or “NCM” means Lithium Nickel Cobalt Manganese Oxide (LiNiCoMnO₂).

“LFP” means Lithium Iron Phosphate (LiFePO₄).

“LMO” means Lithium Manganese Oxide (LiMn₂O₄).

“LNMO” means Lithium Nickel Manganese Spinel (LiNi_{0.5}Mn_{1.5}O₄).

“LCO” means Lithium Cobalt Oxide (LiCoO₂).

“LTO” means Lithium Titanate (Li₂TiO₃).

“NMO” means Lithium Nickel Manganese Oxide (Li(Ni_{0.5}Mn_{0.5})O₂).

“LLZO” means Lithium Lanthanum Zirconium Oxide (Li₇La₃Zr₂O₁₂).

“LLZTO” means Lithium Lanthanum Zirconium Tantalum Oxide (Li_{6.4}La₃Zr_{1.4}Ta_{0.6}O₁₂).

“EC” means Ethylene Carbonate ((CH₂O)₂CO).

“EMC” means Ethyl Methyl Carbonate (C₄H₈O₃).

“DEC” means Diethyl Carbonate (C₅H₁₀O₃).

“DMC” means Dimethyl Carbonate (OC(OCH₃)₂).

“LiFSI” means Lithium bis(fluorosulfonyl)imide (LiC₂NO₄F₆S₂).

“LiTFSI” means Lithium bis(trifluoromethanesulfonyl)imide (LiC₂F₆NO₄S₂).

“DME” means (1,2-dimethoxyethane).

“TEP” means Triethyl Phosphate (C₂H₅)₃PO₄.

“BTFE” means (bis(2,2,2-trifluoroethyl) ether.

“TFTFE” means 1,1,2,2-Tetrafluoroethyl 2,2,2-trifluoroethyl ether.

“PC” means Propylene Carbonate (C₄H₆O₃).

“PVDF-HFP” means (poly(vinylidene fluoride-hexafluoropropylene)).

“Tortuosity” refers to the overall expediency of paths through an electrode. In some examples, the tortuosity of a path through the electrode may refer to the ratio of actual flow path length to the straight distance between the ends of the flow path within the electrode, also known as the arc-chord ratio. In some examples, the overall tortuosity of an electrode may be described by the equation:

$$\frac{τ}{ε} = \frac{{ρ}_{eff}}{{ρ}_{0}} = \frac{{κ}_{0}}{{κ}_{eff}} = \frac{{D}_{0}}{{D}_{eff}} = {N}_{M}$$

where τ is the tortuosity factor; E is the porosity; NM is the MacMullin number; ρ₀, κ₀, and D₀ are, respectively, the “intrinsic” electrical resistivity (Ωm), conductivity (S m⁻¹) and diffusion coefficient (m²s⁻¹) of the electrolyte; and ρ_{eff}, κ_{eff}, and D_{eff} are the observed “effective” values resulting from the transport constraints imposed by a porous and tortuous microstructure.

“Providing,” in the context of a method, may include receiving, obtaining, purchasing, manufacturing, generating, processing, preprocessing, and/or the like, such that the object or material provided is in a state and configuration for other steps to be carried out.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, an electrochemical cell including an integrated separator in accordance with the present teachings may include a first electrode (e.g., an anode) and a second electrode (e.g., a cathode), one or both of which may include an integrated separator layer configured to electrically isolate the first and second electrodes from each other. Each electrode may include at least one electrode layer comprising a plurality of active material particles adhered together by a binder. In some examples, electrodes may include one or more active material layers, each including a plurality of active material particles adhered together by a binder.

The electrode layer may include a first active material layer including a plurality of first active material particles. In some examples, the electrode layer further includes a second active material layer including a plurality of second active material particles, defining a multilayer architecture. The first and second active material layers may have different porosities, different material chemistries, different active material particle sizes, and/or any alternative material property affecting electrode function. The electrode layer may have a thickness, measured as a distance perpendicular to the plane of a current collector to which the electrode is adhered and an opposing (AKA upper) surface of the electrode layer.

The separator layer may include a first plurality of inorganic particles comprising electrochemically inactive and electrically non-conductive materials. In some examples, the inorganic particles may be ceramics such as aluminum oxide (i.e., alumina (α-Al2O3)), corundum, calcined, tabular, synthetic boehmite, silicon oxides or silica, zirconia, and/or the like. In some examples, the inorganic particles may be nitrides, such as hexagonal-boron nitride (h-BN), aluminum nitride (AlN), and/or the like.

Traditional polyolefin separators offer limited protection to the cell in the event of a thermal runaway event. Furthermore, electrochemical cells having high charge and discharge rates increase an operating temperature of the electrochemical cell, decreasing cell performance in the absence of external cooling measures. Higher electrode thermal conductivity (k) allows improved and more uniform heat dissipation. Alumina coatings on polyolefin separators provide some protection in the event of a thermal runaway event. However, the addition of hexagonal-boron nitride (h-BN) to an alumina-based integrated separator significantly increases the thermal conductivity of the integrated separator layer by as much as 400 W/m° K in the plane of the integrated separator. Hexagonal-boron nitride has a thermal conductivity 30-40 times that of alumina and, accordingly, integrated separator layers comprising hexagonal-boron nitride dissipate heat more efficiently than integrated separator layers consisting of ceramics, such as alumina. Typical separators facilitate heat dissipation only through edge planes of the separators. In contrast, separators including nitrides such as hexagonal-boron nitride facilitate heat dissipation throughout the plane of the separator. Further benefits of hexagonal-boron nitride include a decrease in weight of the electrochemical cell, as hexagonal-boron nitride has a density half that of alumina.

However, as hexagonal-boron nitride is found mainly in platelet form, with hexagonal-boron nitride particles comprising flat flakes of material, separators including hexagonal-boron nitride may have a low porosity and a high tortuosity, impeding ion transport through the separator. Hexagonal-boron nitride platelets may align such that planes defined by the platelets are substantially parallel, forming a dense layered material with little or no porosity through which ions may travel. Accordingly, adding a disordering material to a hexagonal-boron nitride separator may create disorder within the separator, increasing a porosity of the separator, and reducing a tortuosity within the separator. Disordering materials may prevent hexagonal-boron nitride particles from fully aligning, introducing pores into the separator. Accordingly, separators according to the present teachings may include a mixture of hexagonal-boron nitride and a disordering material. In some examples, the disordering material comprises any suitable ceramic material, such as aluminum oxide (i.e., alumina (α-Al2O3)), corundum, calcined, tabular, synthetic boehmite, silicon oxides or silica, zirconia, and/or the like. In some examples, particles of the disordering material are substantially spherical in shape. Accordingly, in some examples, electrodes according to the present teachings include integrated separators comprising a mixture of nitrides and ceramic particles. In some examples, electrodes according to the present teachings include integrated separators comprising a mixture of nitrides and disordering particles. In some examples, the nitrides comprise any suitable material having a high thermal conductivity, such as hexagonal-boron nitride, aluminum nitride, and/or the like. In some examples, electrodes according to the present teachings include integrated separators comprising a mixture of hexagonal-boron nitride and alumina (Al₂O₃). In some examples, an integrated separator in accordance with the present teachings includes any suitable volumetric percentage of hexagonal-boron nitride, such as at most 20%, at most 40%, at most 60%, at most 80%, at most 99%, and/or the like. In some examples, an integrated separator in accordance with the present teachings includes any suitable volumetric percentage of alumina, such as up to 20% alumina, up to 40% alumina, up to 60% alumina, up to 80% alumina, up to 99% alumina, and/or the like. In some examples, an integrated separator in accordance with the present teachings has any suitable thickness, such as from 1 μm to 30 μm. In some examples, an integrated separator in accordance with the present teachings has any suitable porosity, such as from 20% to 95%. In some examples, an integrated separator in accordance with the present teachings includes proportions of hexagonal-boron nitride and alumina configured to maximize thermal conductivity, minimize tortuosity, and control porosity.

In some examples, the ceramic particles may have a D50 and/or an average D50 (AKA mass-median diameter) between 100 nm and 10 μm. The separator layer may be configured such that the separator isolates the electrode (e.g., anode or cathode) from an adjacent electrode included within the electrochemical cell, while maintaining permeability to a charge carrier such as a lithium-ion containing electrolyte. In some examples, both electrodes may include a separator layer such that each electrode is similarly isolated.

In some examples, the electrochemical cell may further include a mono-layer polyolefin film disposed between the first electrode and the second electrode, which may provide a thermal shutoff mechanism for the electrochemical cell. The polyolefin film may melt at high temperatures, which may shut off ion flow between electrodes, increasing cell safety. The polyolefin film may comprise any suitable polyolefin, such as polyethylene, polypropylene, and/or any suitable thermoplastic polyolefin. In some examples, the mono-layer polyolefin film may have a thickness less than 20 μm. In some examples, the mono-layer polyolefin film may have a thickness less than 10 μm.

In general, an electrode in accordance with the present teachings includes a first electrode layer layered onto a current collector substrate. The first electrode layer comprises a first plurality of active material particles adhered together by a first binder. The electrode includes one or more additional electrode layers layered onto the first electrode layer. In some examples, the electrode includes a second electrode layer comprising a second plurality of active material particles adhered together by a second binder. In some examples, the electrode includes an integrated separator layer comprising a first plurality of electrochemically inactive and electrically non-conductive particles adhered together by a third binder. In some examples, the second electrode layer is layered onto and directly contacting the first electrode layer. In some examples, the integrated separator layer is layered onto and directly contacting the first electrode layer. In some examples, the second electrode layer is layered onto and directly contacting the first electrode layer, and the integrated separator layer is layered onto and directly contacting the second electrode layer. Electrodes in accordance with the present teachings may have any suitable polarity and, accordingly, may comprise either anodes or cathodes. Electrodes in accordance with the present teachings may be layered to form an electrode stack, including alternating anodes and cathodes with separators interposed between the anodes and the cathodes.

In some examples, electrodes in accordance with the present teachings further comprise interlocking regions disposed between adjacent layers. The interlocking region may include a non-planar interpenetration of a first layer (e.g., the first electrode layer) and a second layer (e.g., the second electrode layer, the separator layer), in which first fingers or protrusions of the first layer interlock with second fingers or protrusions of the second layer. The interlocking layer or interface region created by the interpenetration of the first layer and the second layer may reduce interfacial resistance and increase ion mobility through the electrode. In examples including an integrated separator, the integrated separator may also prevent particle pulverization on active material surface of electrode, which may impede flow of ions.

In some examples, an electrode in accordance with the present teachings is a cathode including a protective strip applied to tabs of the cathode. Electrodes included in stacked electrode cells are punched (e.g., by a machining tool), which may produce burrs or other irregularities around edges of the punched electrode. More specifically, punching the electrode may cause burrs to form at edges of the current collector substrate, which typically comprises a metal foil. Burrs or other irregularities may cause shorting when the burrs of the cathode current collector contact an anode or anode current collector when the electrode stack is assembled. Burrs are particularly problematic when disposed at tab regions of the cathode. In cathodes including integrated ceramic separators, the integrated ceramic separator may wrap around edges of the electrode layers and current collector substrates, insulating the cathode from the anode. However, tabs of the cathode comprise bare current collector substrate (i.e., uncoated by electrode or separator layers). Accordingly, insulating the tabs of the cathode with a protective strip may prevent shorting between the anode and the cathode in locations where the cathode tab overlaps with the anode edge.

Specifically, insulating the tab with a strip of polymer or wax insulates the cathode tab from the anode. The protective strip may be applied at any suitable stage of cell manufacturing, such as before punching or after punching. In some examples, the protective strip comprises a polymer, such as polypropylene, polyethylene, polyimine, polyethylene terephthalate, etc., a wax, such as paraffin, polyethylene, Fischer Tropsch, stearic acid, etc., and/or the like. In some examples, a method of applying the protective strip to the cathode tab comprises extruding or laminating the protective strip onto an intersection region between the cathode tab and the anode. In some examples, the protective strip is applied to the cathode before punching. In some examples, the protective strip is applied in a slurry bead using any suitable method, such as spraying, coating, and/or the like. In some examples, the protective strip is manufactured substantially simultaneously with one or more electrode layers the cathode, such as by a multi-orificed slot die dispenser depositing the cathode composite. In some examples, extruding or laminating the protective strip onto the intersection point includes utilizing a lamination machine typically utilized in manufacturing and/or sealing electrode packaging to apply the protective strip to the intersection region.

In some examples, the electrochemical cell includes a single separator layer interlocked with both a first electrode and a second electrode. Accordingly, in some examples, a method of manufacturing an electrochemical cell includes bonding and/or adhering a first integrated separator layer comprising a first plurality of inorganic particles to a second integrated separator layer comprising a second plurality of inorganic particles, thereby forming a single separator layer, wherein the first integrated separator layer is substantially indistinguishable from the second separator layer.

In some examples, methods of bonding a first integrated separator layer to a second integrated separator layer comprise applying a plasticizing solvent to a separator interface between the first integrated separator layer and the second integrated separator layer, increasing a plasticity of the first integrated separator layer and/or the second integrated separator layer at the interface by re-solvating binders included in the first integrated separator layer and the second integrated separator layer. By re-solvating the binders, the solvated binders may be induced to function as an adhesive at the separator interface, adhering both constituent inorganic particles of the respective first and second integrated separator layers to each other and adhering the first inorganic particles of the first integrated separator layer to the second inorganic particles of the second integrated separator layer. Furthermore, increasing a plasticity at the interface may cause the first plurality of inorganic particles and the second plurality of inorganic particles to move relative to each other, thereby increasing a surface area of the separator interface.

In some examples, applying a plasticizing solvent to the separator interface increases a flexibility of composite materials forming the first integrated separator and/or the second integrated separator layer, facilitating integration and/or interpenetration between the first integrated separator layer and/or the second integrated separator layer, thereby forming a single separator layer. In some examples, applying the plasticizing solvent may be performed after drying of the first and/or the second electrode. Accordingly, binders of dried integrated separator layers may be solvated by the plasticizing solvent, facilitating movement of previously immobilized separator particles. In some examples, the plasticizing solvent comprises any suitable substance configured to increase the plasticity of a separator composite, such as an electrolyte, N-Methyl pyrrolidone (NMP), cyclic carbonates, esters, ethers, monomeric solvents, polymeric solvents, and/or the like.

In some examples, applying the plasticizing solvent to the separator interface between the first integrated separator layer and the second integrated separator layer comprises applying the plasticizing solvent to the first integrated separator layer, the second integrated separator layer, and/or the first integrated separator layer utilizing any suitable method, such as spraying, coating, misting, and/or the like. In some examples, applying the plasticizing solvent to the separator interface between the first integrated separator layer and the second integrated separator layer comprises applying a slurry forming a third integrated separator layer to surfaces of the first and/or the second integrated separator layer. In some examples, the slurry forming the third integrated separator layer is configured to have a higher binder concentration than the first integrated separator layer and/or the second integrated separator layer. In some examples, the third integrated separator layer is configured to have a porosity within 20% of the first integrated separator layer and the second integrated separator layer.

In some examples, the method of manufacturing the electrochemical cell comprises selectively applying the plasticizing solvent at selected regions of the interface, such as at regions adjacent to tabs of the cathode. In some examples, the method of manufacturing the electrochemical cell includes applying an electrolyte to a packaged cell, thereby causing binders within the cell to swell and soften, leaving residual solvent to function as a plasticizing agent at the interface. In some examples, the method of manufacturing the electrochemical cell comprises applying excess electrolyte to a packaged cell, such that excess electrolyte within the packaged cell plasticizes binders included in the first integrated separator layer and the second integrated separator layer, forming, the single separator layer. In some examples, insulating the tab of the cathode comprises applying a plasticizing solvent to the separator interface in regions of the first integrated separator layer and/or the second integrated separator layer adjacent to the tab of the cathode.

In some examples, applying the plasticizing solvent to the separator interface lowers a glass transition temperature of binders within the first integrated separator layer and the second integrated separator layer. Accordingly, subsequently calendering the cell causes the binders to fuse together at a lower temperature that would otherwise be required.

In some examples, methods of bonding a first integrated separator layer to a second integrated separator layer comprise polymerizing binders, oligomers, and/or monomers disposed at a separator interface between the first integrated separator layer and the second integrated separator layer. In some examples, bonding the first integrated separator layer to the second integrated separator layer comprises applying a polymerizing agent at the separator interface. In some examples, bonding the first integrated separator layer to the second integrated separator layer comprises applying heat to the separator interface, thereby activating polymerizing agents disposed within the first integrated separator layer and the second integrated separator layer. In some examples, the binder comprises any suitable material or mixture of materials which forms a crosslinked matrix upon calendering, such as poly(vinyl alcohol)/poly(acrylic acid) (PVA-PAA) (esterification crosslinking), carboxymethyl cellulose/poly(acrylic acid) (CMC-PAA) (esterification crosslinking), carboxymethyl cellulose/polyethylene glycol (CMC-PEG) (epoxide crosslinking), poly(vinyl pyrollidine) crosslinking, and/or the like. Accordingly, upon application of heat and pressure during the calendering process, the binders in the adjacent first integrated separator layer and the second integrated separator layer crosslink, reversibly or irreversibly binding the layers and forming the unified separator layer. In some examples, calendering the electrochemical cell comprises applying high-energy radiation, such as ultraviolet (UV), gamma radiation, and/or the like to the electrochemical cell, causing irreversible or reversible cross-linking reactions between the binders and forming the unified separator layer.

In some examples, bonding the first integrated separator layer to the second integrated separator layer comprises applying an activating substance to the interface, thereby activating polymerizing agents disposed within the first integrated separator layer and the second integrated separator layer. In some examples, the activating substance comprises a polymerization initiator, such as an azo initiator, a peroxide initiator, and/or the like. In some examples, the activating substance comprises a pH-mediating substance, such as oxalic acid, boronic acid, and/or the like. In some examples, the activating substance comprises a plasticizing solvent, such as an electrolyte, N-Methyl pyrrolidone (NMP), cyclic carbonates, esters, ethers, monomeric solvents, polymeric solvents, and/or the like. In some examples, bonding the first integrated separator layer to the second integrated separator layer comprises applying oligomers and/or monomers to the separator interface, such as ethylene, vinyl chloride, propylene, esters, and/or the like. Accordingly, in some examples, bonding the first integrated separator layer to the second integrated separator layer comprises spraying a cyclic ether onto the separator interface. In some examples, bonding the first integrated separator layer to the second integrated separator layer comprises applying 0.1 mm polymer nitrate onto the separator interface.

In some examples, bonding the first integrated separator layer to the second integrated separator layer comprises controlling a degree of crosslinking at the separator interface and within remaining portions of the first integrated separator layer and the second integrated separator layer, facilitating a desired porosity profile at different regions of the single separator layer. For example, increasing crosslinking within the separator layer may increase a tortuosity of the separator layer. Accordingly, polymerizing binders included in the first integrated separator layer and the second integrated separator layer may facilitate ion transport through the separator, facilitating increased cohesion at the separator layer without decreasing a charge and/or discharge speed of the electrochemical cell. Systems and methods according to the present disclosure provide a tailored crosslinking and/or porosity profile inducing increased polymerization at the separator interface to increase adhesion. In some examples, oligomers and/or monomers may be included throughout the first integrated separator and the second integrated separator, but the activating substance may be applied only at the separator interface. In some examples, oligomers and/or monomers are applied only at the separator interface, facilitating increased cross-linking at the interface when compared with other regions of the first integrated separator and the second integrated separator. In some examples, applying oligomers and/or monomers to the separator interface comprises a slurry forming a third integrated separator layer to surfaces of the first and/or the second integrated separator layer, wherein the slurry comprises the oligomers and/or monomers. In some examples, the third integrated separator layer is configured to have a porosity within 20% of the first integrated separator layer and the second integrated separator layer. In some examples, polymerization within the first integrated separator layer and/or the second integrated separator layer is configured to insulate the tab of the cathode. Accordingly, in some examples, oligomers and/or monomers are applied to regions of the separator interface adjacent the tab of the cathode. In these examples, the oligomers and/or monomers may be included in a slurry forming a cathode integrated separator (i.e., either the first integrated separator or the second integrated separator). Accordingly, when polymerization is induced, the cathode integrated separator crosslinks to a greater degree than the anode integrated separator.

In some examples, oligomers and/or monomers included in the first integrated separator and/or the second integrated separator are configured to crosslink upon application of a first activation method, and oligomers and/or monomers included at the separator interface are configured to crosslink upon application of a second activation method. Accordingly, oligomers and/or monomers may be incorporated into a slurry forming the first integrated separator and/or the second integrated separator. For example, binders included in the first integrated separator and/or the second integrated separator may be configured to crosslink upon application of heat. However, oligomers and/or monomers incorporated into the slurry may be configured to crosslink upon application of a plasticizing solvent, the application of a higher temperature than that previously applied, the application of an electrolyte, and/or the like. In some examples, polymerization within the first integrated separator and/or the second integrated separator is induced during a drying and/or calendering process, and bonding at the separator interface is induced by heating the previously-formed polymers almost to their melting point, such as by laminating the electrochemical cell, thereby bonding the polymer molecules to each other. In some examples, the first integrated separator layer and/or the second integrated separator layer are configured to induce polymerization upon contact. In these examples, one of the first integrated separator layer and the second integrated separator layer includes oligomers and/or monomers and the other one of the first integrated separator layer includes an activating substance configured to initiate polymerization. Upon stacking of the first electrode and the second electrode, polymerization is induced at the separator interface. In some examples, the activating substance comprises a polymeric initiator such as an azo initiator, a peroxide initiator, and/or the like. In some examples, the activating substance comprises a pH-mediating substance such as oxalic acid, boronic acid, and/or the like.

In general, a method of manufacture for an electrochemical cell including an integrated separator includes providing an anode and providing a cathode, at least one of which includes an integrated separator. In some examples, the method further includes providing a polyolefin separator film, such that the polyolefin film is disposed between the cathode and the anode. In some examples, the method further includes calendering or compressing a cell stack including a plurality of stacked cathodes and anodes. In some examples, the method further includes packaging the electrochemical cell, such as in a can (e.g., for a wound cell), or a pouch bag (e.g., for a pouch cell).

In some examples, electrodes according to the present teachings are included within wound cells. Accordingly, in some examples, a method of manufacturing electrodes including integrated separators includes: applying an integrated separator layer to one or more electrodes of an electrochemical cell (e.g., an anode and/or a cathode), fully and/or partially pre-calendering each electrode with the integrated ceramic separator, optionally applying an adhesive to top layers of one or both electrodes, optionally bonding a first integrated ceramic separator layer of a first electrode to a second integrated ceramic separator layer of a second electrode and simultaneously pressing, calendering, and laminating the electrodes as a unit.

### Examples, Components, and Alternatives

The following sections describe selected aspects of illustrative electrochemical cells having integrated ceramic separators, as well as related systems and/or methods.

The examples in these sections are intended for illustration and should not be interpreted as limiting the scope of the present disclosure. Each section may include one or more distinct embodiments or examples, and/or contextual or related information, function, and/or structure.

### A. Illustrative Electrochemical Cell

This section describes an electrochemical cell including a positive and negative electrode having a separator disposed between them in accordance with aspects of the present teachings. The electrochemical cell may be any bipolar electrochemical device, such as a battery (e.g., lithium-ion battery, secondary battery).

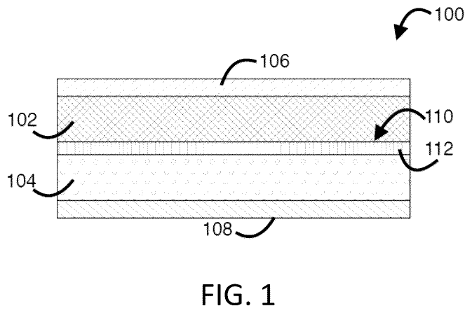

Referring now to FIG. 1, an electrochemical cell 100 is illustrated schematically in the form of a lithium-ion battery. Electrochemical cell 100 includes a positive and a negative electrode, namely a cathode 102 and an anode 104. The cathode and anode are sandwiched between a pair of current collectors 106, 108, which may comprise metal foils or other suitable substrates. Current collector 106 is electrically coupled to cathode 102 and current collector 108 is electrically coupled to anode 104. The current collectors enable the flow of electrons, and thereby electrical current, into and out of each electrode. An electrolyte 110 disposed throughout the electrodes enables the transport of ions between cathode 102 and anode 104. In the present example, electrolyte 110 includes a liquid solvent and a solute of dissolved ions. Electrolyte 110 facilitates an ionic connection between cathode 102 and anode 104.

Electrolyte 110 is assisted by a separator 112, which physically partitions the space between cathode 102 and anode 104. Separator 112 is liquid permeable and enables the movement (AKA flow) of ions within electrolyte 110 and between the two electrodes. In some examples, separator 112 comprises a solid ion conducting material. Separator 112 may prevent dendritic growth through the electrochemical cell. In some examples, separator 112 is a porous polyolefin film permeated with liquid electrolyte. In some examples, the separator is a solid oxide-based lithium ion conductor, such as garnet-type LLZO (lithium lanthanum zirconium oxide)/LLZTO (lithium lanthanum zirconium tantalum oxide) ceramics with densities >95%, and/or the like. As described further below, separator 112 may be integrated within one or both of cathode 102 and anode 104. In some examples, separator 112 comprises a layer of electrochemically inactive and electrically non-conductive particles, such as ceramics, nitrides, and/or the like applied to a top surface of cathode 102, such that the ceramic particles of separator 112 are interpenetrated or intermixed with active material particles of cathode 102 or anode 104.

Cathode 102 and anode 104 are composite structures, which comprise active material particles, binders, conductive additives, and pores (void space) into which electrolyte 110 may penetrate. An arrangement of the constituent parts of an electrode is referred to as a microstructure, or more specifically, an electrode microstructure.

In some examples, the binder is a polymer, e.g., polyvinylidene difluoride (PVdF), and the conductive additive typically includes a nanometer-sized carbon, e.g., carbon black or graphite. In some examples, the binder is a mixture of carboxyl-methyl cellulose (CMC) and styrene-butadiene rubber (SBR). In some examples, the conductive additive includes a ketjen black, a graphitic carbon, a low dimensional carbon (e.g., carbon nanotubes), and/or a carbon fiber. In some examples, binders may comprise colloidal dispersions (AKA latexes) and/or emulsions, such as styrene-butadiene rubber (SBR), poly(vinylidene fluoride) (PVDF), poly(vinylidene fluoride-co-hexafluoropropylene) (PVDF-HFP), wax emulsions, and/or the like or micron and/or nano-sized wax and/or polymer particles, such as polyethylene, fischer-tropsch waxes, soy (or other bio-based) waxes, polyethylene oxide wax, and/or the like, which may coalesce upon calendering, forming a homogeneous structure comprising interdiffused polymer chains. In some examples, the binder comprises any suitable material or mixture of materials which forms a crosslinked matrix upon calendering, such as poly(vinyl alcohol)/poly(acrylic acid) (PVA-PAA) (esterification crosslinking), carboxymethyl cellulose/poly(acrylic acid) (CMC-PAA) (esterification crosslinking), carboxymethyl cellulose/polyethylene glycol (CMC-PEG) (epoxide crosslinking), poly(vinyl pyrollidine) crosslinking, and/or the like. In some examples, the binder comprises any suitable material which does not coalesce upon calendering, such as sodium carboxymethyl cellulose (NaCMC), poly(vinyl alcohol) (PVA), poly(acrylic acid) (PAA), sodium poly(acrylic acid) (NaPAA), sodium alginate, chitosan, guar gum, xanthan gum, polyethylene glycol, and/or the like.

In some examples, the chemistry of the active material particles differs between cathode 102 and anode 104. For example, anode 104 may include graphite (artificial or natural), hard carbon, soft carbon, titanate, titania, transition metals in general, elements in group 14 (e.g., carbon, silicon, tin, germanium, etc.), oxides, sulfides, transition metals, halides, and/or chalcogenides. On the other hand, cathode 102 may include transition metals (for example, nickel, cobalt, manganese, copper, zinc, vanadium, chromium, iron), and their oxides, phosphates, phosphites, silicates, alkalines and alkaline earth metals, aluminum, aluminum oxides and aluminum phosphates, halides, chalcogenides, and/or the like. In some examples, cathode 102 includes lithium-containing transition metal oxides, such as lithium nickel cobalt aluminum oxide (NCA), lithium nickel cobalt manganese oxide (NMC), lithium iron phosphate (LFP), lithium manganese oxide (LMO), lithium nickel manganese spinel (LNMO), lithium cobalt oxide (LCO), lithium titanate (LTO), lithium nickel manganese oxide (NMO), and/or the like.

In an electrochemical device, active materials participate in an electrochemical reaction or process with a working ion to store or release energy. For example, in a lithium-ion battery, the working ions are lithium ions.

Electrochemical cell 100 may include packaging (not shown). For example, packaging (e.g., a prismatic can, stainless steel tube, polymer pouch, etc.) may be utilized to constrain and position cathode 102, anode 104, current collectors 106 and 108, electrolyte 110, and separator 112.

For electrochemical cell 100 to properly function as a secondary battery, active material particles in both cathode 102 and anode 104 must be capable of storing and releasing lithium ions through the respective processes known as lithiating and delithiating. Some active materials (e.g., layered oxide materials or graphitic carbon) fulfill this function by intercalating lithium ions between crystal layers. Other active materials may have alternative lithiating and delithiating mechanisms (e.g., alloying, conversion).

When electrochemical cell 100 is being charged, anode 104 accepts lithium ions while cathode 102 donates lithium ions. When a cell is being discharged, anode 104 donates lithium ions while cathode 102 accepts lithium ions. Each composite electrode (i.e., cathode 102 and anode 104) has a rate at which it donates or accepts lithium ions that depends upon properties extrinsic to the electrode (e.g., the current passed through each electrode, the conductivity of the electrolyte 110) as well as properties intrinsic to the electrode (e.g., the solid state diffusion constant of the active material particles in the electrode; the electrode microstructure or tortuosity; the charge transfer rate at which lithium ions move from being solvated in the electrolyte to being intercalated in the active material particles of the electrode; etc.).

During either mode of operation (charging or discharging) anode 104 or cathode 102 may donate or accept lithium ions at a limiting rate, where rate is defined as lithium ions per unit time, per unit current. For example, during charging, anode 104 may accept lithium at a first rate, and cathode 102 may donate lithium at a second rate. When the second rate is lesser than the first rate, the second rate of the cathode would be a limiting rate. In some examples, the differences in rates may be so dramatic as to limit the overall performance of the lithium-ion battery (e.g., cell 100). Reasons for the differences in rates may depend on an energy required to lithiate or delithiate a quantity of lithium-ions per mass of active material particles; a solid state diffusion coefficient of lithium ions in an active material particle; and/or a particle size distribution of active material within a composite electrode. In some examples, additional or alternative factors may contribute to the electrode microstructure and affect these rates.

### B. Illustrative Electrode Having Integrated Separator

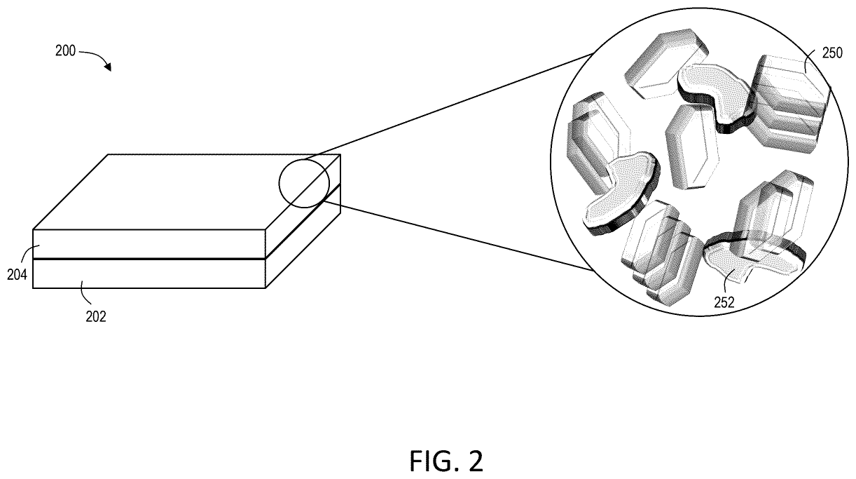

This section describes illustrative electrodes and electrochemical cells having integrated separators in accordance with the present teachings. FIG. 2 depicts an illustrative electrode 200 comprising one or more electrode layers 202 and an integrated separator layer 204. Electrode 200 is an example of an anode or cathode suitable for inclusion in an electrochemical cell, similar to cathode 102 or anode 104, described above. Active material layer 202 is disposed on and directly in contact with a current collector substrate. Active material layer 202 includes a plurality of first active material particles 240 adhered together by a first binder. Active material layer 202 may further include a conductive additive mixed with the active material particles. In some examples, the binder is a polymer, e.g., polyvinylidene difluoride (PVdF), and the conductive additive typically includes a nanometer-sized carbon, e.g., carbon black or graphite. In some examples, the binder is a mixture of carboxyl-methyl cellulose (CMC) and styrene-butadiene rubber (SBR). In some examples, the conductive additive includes a ketjen black, a graphitic carbon, a low dimensional carbon (e.g., carbon nanotubes), and/or a carbon fiber.

In some examples, electrode 200 is an anode suitable for inclusion within an electrochemical cell. In the case of such an anode, active material particles 240 may comprise graphite (artificial or natural), hard carbon, soft carbon, titanate, titania, transition metals in general, elements in group 14 (e.g., carbon, silicon, tin, germanium, etc.), oxides, sulfides, transition metals, halides, and/or chalcogenides.

In some examples, electrode 200 is a cathode suitable for inclusion within an electrochemical cell. In the case of such a cathode, active material particles 240 may comprise transition metals (for example, nickel, cobalt, manganese, copper, zinc, vanadium, chromium, iron), and their oxides, phosphates, phosphites, and silicates. In some examples, the cathode active material particles may include alkalines and alkaline earth metals, aluminum, aluminum oxides and aluminum phosphates, halides, and/or chalcogenides.

As depicted in FIG. 2, integrated separator layer 204 includes a mixture of nitrides 250 and disordering materials 252. Nitrides 250 are substantially platelet-shaped, flake-shaped, and/or the like, and, accordingly, form a dense low-porosity separator layer. Accordingly, the introduction of disordering particles 252 to an integrated separator layer including nitrides may increase a porosity and decrease a tortuosity of integrated separator layer 204. Integrated separator layer 204 is layered onto active material layer 202, and includes a plurality of disordering particles 252 and a plurality of nitride particles 250 adhered together by a second binder.

As stated above, traditional polyolefin separators offer limited protection to the cell in the event of a thermal runaway event. Furthermore, increased charge and discharge rates increase an operating temperature of a cell, decreasing performance. In some examples, increased operating temperature necessitates external cooling measures. Accordingly, decreasing the operating temperature of an electrochemical cell would increase cell performance.

Higher electrode thermal conductivity (k) allows improved and more uniform heat dissipation. Accordingly, integrated separator layer comprising materials with high thermal conductivity decrease the operating temperature of a cell. The addition of nitrides such as hexagonal-boron nitride (h-BN) to an integrated separator significantly increases the thermal conductivity of the integrated separator layer by as much as 400 W/m° K in the plane of the integrated separator. Hexagonal-boron nitride has a thermal conductivity 30-40 times that of alumina and, accordingly, integrated separator layers comprising hexagonal-boron nitride dissipate heat more efficiently than integrated separator layers consisting of ceramics, such as alumina. Further benefits of hexagonal-boron nitride include a decrease in weight of the electrochemical cell, as hexagonal-boron nitride has a density half that of alumina.

However, as hexagonal-boron nitride is found mainly in platelet form, with hexagonal-boron nitride particles comprising flat flakes of material, separators including hexagonal-boron nitride may have a low porosity and a high tortuosity, impeding ion transport through the separator. Hexagonal-boron nitride platelets may align within the plane of the separator, forming a dense layered with low porosity. Accordingly, adding a disordering material to a hexagonal-boron nitride separator may prevent hexagonal-boron nitride particles from fully aligning, introducing, or preserving pores within the separator. Accordingly, separators according to the present teachings may include a mixture of nitrides and a disordering material.

Nitrides 250 may comprise any suitable material having a high thermal conductivity, such as aluminum nitride, hexagonal-boron nitride, and/or the like. Disordering particles 252 comprise any suitable inorganic material or materials, including ceramics such as aluminum oxide (i.e., alumina (α-Al₂O₃)), corundum, calcined, tabular, synthetic boehmite, silicon oxides or silica, zirconia, and/or the like. Disordering particles 252 may be electrically non-conductive. In some examples, disordering particles 252 are substantially spherical in shape. Integrated separator layer 204 may comprise any suitable volumetric percentages of nitrides 250, such as up to 20% nitrides, up to 40% nitrides, up to 60% nitrides, up to 80% nitrides, up to 99% nitrides, and/or the like. Similarly, integrated separator layer 204 may comprise any suitable volumetric percentages of disordering particles 252, such as up to 20% disordering particles, up to 40% disordering particles, up to 60% disordering particles, up to 80% disordering particles, up to 99% disordering particles, and/or the like.

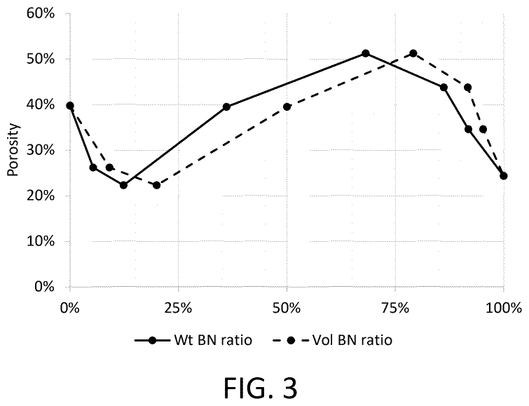

FIG. 3 depicts the porosity of an integrated separator including a mixture of hexagonal-boron nitride and alumina as a function of a volumetric percentage or percentage by weight of hexagonal-boron nitride within the integrated separator. As depicted in FIG. 3, a porosity of the separator layer decreases from approximately 0% by weight to 12% by weight of hexagonal-boron nitride, then increases to a maximum porosity of approximately 50% at a hexagonal-boron nitride weight percentage of approximately 67%, before decreasing. Similarly, a porosity of the separator layer decreases from approximately 0% by volume to 20% by volume of hexagonal-boron nitride, then increases to a maximum porosity of approximately 50% at a volumetric hexagonal-boron nitride percentage of approximately 79%. Accordingly, in some examples, integrated separator layer 204 includes from 50% to 85% hexagonal-boron nitride by weight, from 60% to 75% hexagonal-boron nitride by weight, from 65% to 70% hexagonal-boron nitride by weight, approximately 67% hexagonal-boron nitride, and/or the like. Similarly, in some examples, integrated separator layer 204 includes from 60% to 92% hexagonal-boron nitride by volume, from 70% to 85% hexagonal-boron nitride by volume, from 77% to 82% hexagonal-boron nitride by volume, approximately 79% hexagonal-boron nitride by volume, and/or the like.

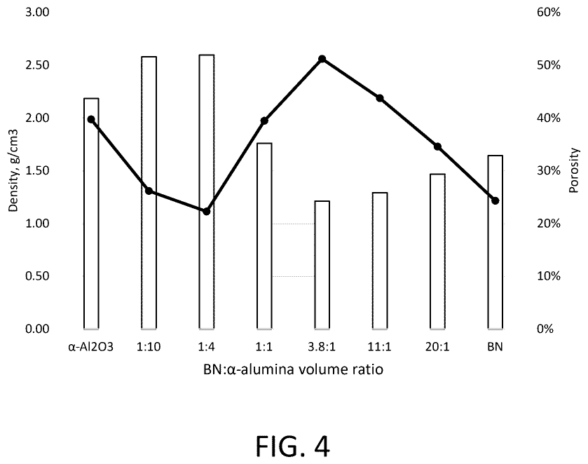

FIG. 4 depicts the density and porosity of an integrated separator including a mixture of hexagonal-boron nitride and alumina as a function of a volumetric ratio of hexagonal-boron nitride to alumina. As depicted in FIG. 4, the integrated separator has a maximum porosity and a minimum density when a volumetric ratio of hexagonal-boron nitride to alumina is 3.8:1. Accordingly, in some examples, integrated separator layer 204 has a volumetric ratio of hexagonal-boron nitride to alumina from 1:1 to 11:1, from 2:1 to 5:1, from 3.5:1 to 4.3:1, approximately 3.8:1, and/or the like. Accordingly, in some examples, integrated separator layer 204 comprises approximately 80% hexagonal-boron nitride and approximately 20% alumina by volume.

In some examples, an integrated separator in accordance with the present teachings has any suitable thickness, such as from 1 μm to 30 μm, from 3 μm to 16 μm, from 5 μm to 23 μm, and/or the like. In some examples, an integrated separator in accordance with the present teachings has any suitable porosity, such as from 20% to 95%. In some examples, the integrated separator has a porosity greater than 40%. In some examples, an integrated separator in accordance with the present teachings includes proportions of hexagonal-boron nitride and alumina configured to maximize thermal conductivity, minimize tortuosity, and control porosity.

Integrated separator layer 204 may comprise varying mass fractions of inorganic particles (e.g., ceramic particles) and varying mass fractions of binders and other additives. In some examples, the separator layer is between 50% and 99% inorganic material. In other examples, the separator layer is greater than 99% inorganic material and less than 1% binder. In the examples having greater than 99% inorganic material, the electrode may be manufactured in a similar fashion to electrodes with separator layers having lower percentages of inorganic material, optionally followed by ablation of excess binder during post-processing.

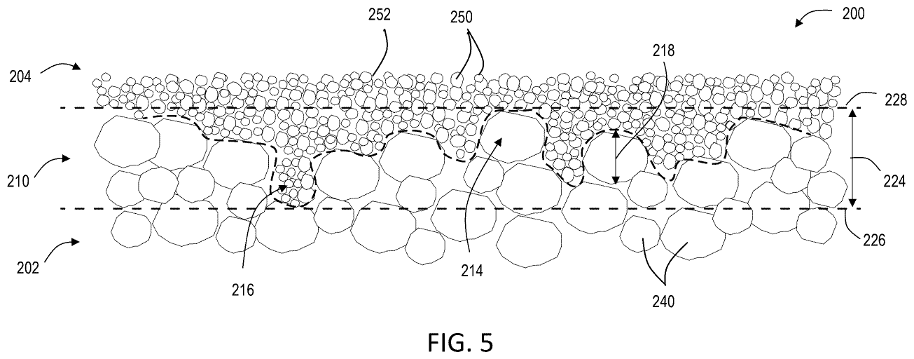

In some examples, electrode 200 further comprises an interlocking region 210 disposed between active material layer 202 and integrated separator layer 204. Interlocking region 210 comprises a non-planar boundary between active material layer 202 and integrated separator layer 204, configured to decrease interfacial resistance between the layers and reduce lithium plating on the electrode layer. Turning now to FIG. 5, an illustrative interlocking region between an integrated separator layer 204 and an electrode layer 202 is shown and described. Operation of an energy storage device under demanding conditions at the limits of an electrode's capabilities may require the accommodation of stresses induced by volume expansion (swelling) and contraction during the charging and discharging of battery electrodes. This may introduce structural and functional challenges, as an electrochemical cell including the electrode may have one or more layers, each swelling or contracting at different rates during battery charging and discharging. More specifically, active material layers of electrodes may expand and contract during battery use, while inert separator particles may remain constant in size. In some examples, additional components of electrochemical cells may shrink or expand at different rates during battery use. For example, polyolefin separators, commonly used in lithium-ion batteries, may shrink while an adjacent electrode expands, increasing the risk that a battery including the electrode will short during use.

Ensuring continued structural integrity of an electrode-separator interface is therefore necessary to prevent shorting between cathodes and anodes included in the battery, introducing several design considerations. A mechanical integrity or coherence of the electrochemical cell must be maintained so that an electrode and an adjacent separator remain mechanically stable and adhered to each other. Additionally, an interface between the active material layers and the separator should not block or inhibit a flow of ions through the electrochemical cell. In the case of an anode, the interface between the layers should not create regions of increased densification. Such increased densification can result in solid electrolyte interphase (SEI) buildup at the interface between the layers that subsequently blocks pores and induces lithium plating. These issues present challenges to be addressed in the production of an electrochemical cell with a separator.

Accordingly, in some examples, electrode 200 includes an interlocking region 210 disposed between active material layer 202 and separator layer 204. An example of interlocking region 210 is depicted in FIG. 5. While particles 250, 252 of separator 204 appear homogeneous, it is understood that nitride particles 250 are substantially platelet-shaped, while disordering particles 252 are substantially spherical in shape. Active material layer 202 and separator layer 204 may have respective, three-dimensional, interpenetrating fingers 214 and 216 that interlock the two layers together, forming a mechanically robust interface that is capable of withstanding stresses, such as those due to electrode expansion and contraction, and separator shrinking. Additionally, the non-planar surfaces defined by fingers 214 and fingers 216 represent an increased total surface area of the interface boundary, which may provide reduced interfacial resistance and may increase ion mobility through the electrode. Fingers 214 and 216 may be interchangeably referred to as fingers, protrusions, extensions, projections, and/or the like. Furthermore, the relationship between fingers 214 and 216 may be described as interlocking, interpenetrating, intermeshing, interdigitating, interconnecting, interlinking, and/or the like.

Fingers 214 and fingers 216 are a plurality of substantially discrete interpenetrations, wherein fingers 214 are generally made up of electrode active material particles 240 and fingers 216 are generally made up of ceramic separator particles 250. The fingers are three-dimensionally interdigitated, analogous to an irregular form of the stud-and-tube construction of Lego bricks. Accordingly, fingers 214 and 216 typically do not span the electrode in any direction, such that a cross section perpendicular to that of FIG. 5 will also show a non-planar, undulating boundary similar to the one shown in FIG. 5. Interlocking region 210 may alternatively be referred to as a non-planar interpenetration of active material layer 202 and separator layer 204, including fingers 214 interlocked with fingers 216.

As shown in FIG. 5, although fingers 214 and 216 may not be uniform in size or shape, the fingers may have an average or typical length 218. In some examples, length 218 of fingers 214 and 216 may fall in a range between two and five times the average particle size of the first active material layer or the separator layer, whichever is smaller. In some examples, length 218 of fingers 214, 216 may fall in a range between six and ten times the average particle size of the first active material layer or the separator layer, whichever is smaller. In some examples, length 218 of fingers 214 and 216 may fall in a range between eleven and fifty times the average particle size of the first active material layer or the separator layer, whichever is smaller. In some examples, length 218 of fingers 214 and 216 may be greater than fifty times the average particle size of the first active material layer or the separator layer, whichever is smaller.

In some examples, length 218 of fingers 214 and 216 may fall in a range of approximately five hundred to approximately one thousand nanometers. In some examples, length 218 of fingers 214 and 216 may fall in a range of approximately one to approximately five μm. In some examples, length 218 of fingers 214 and 216 may fall in a range between approximately six and approximately ten μm. In another example, length 218 of fingers 214 and 216 may fall in a range between approximately eleven and approximately fifty μm. In another example, length 218 of fingers 214 and 216 may be greater than approximately fifty μm.

In the present example, a total thickness 224 of interlocking region 210 is defined by the level of interpenetration between the two electrode material layers (first active material layer 202 and separator layer 204). A lower limit 226 may be defined by the lowest point reached by separator layer 204 (i.e., by fingers 216). An upper limit 228 may be defined by the highest point reached by first active material layer 202 (i.e., by fingers 214). Total thickness 224 of interlocking region 210 may be defined as the separation or distance between limits 226 and 228. In some examples, the total thickness of interlocking region 210 may fall within one or more of various relative ranges, such as between approximately 200% (2×) and approximately 500% (5×), approximately 500% (5×) and approximately 1000% (10×), approximately 1000% (10×) and approximately 5000% (50×), and/or greater than approximately 5000% (50×) of the average particle size of the first active material layer or the separator layer, whichever is smaller.

In some examples, total thickness 224 of interlocking region 210 may fall within one or more of various absolute ranges, such as between approximately 500 and one thousand nanometers, one and approximately ten μm, approximately ten and approximately fifty μm, and/or greater than approximately fifty μm.

In the present example, first active material particles 240 in first active material layer 202 have a distribution of volumes which have a greater average than an average volume of nitrides 250 and disordering particles 252 in separator layer 204 i.e., a larger average size. In some examples, first active material particles 240 have a collective surface area that is less than the collective surface area of nitrides 250 and disordering particles 252.

In examples including interlocking region 210, when particles of electrode 200 are lithiating or delithiating, electrode 200 remains coherent, and the first active material layer and the separator layer remain bound by interlocking region 210. In general, the interdigitation or interpenetration of fingers 214 and 216, as well as the increased surface area of the interphase boundary, function to adhere or couple the two zones together.

In one example, electrode 200 is a portion of a cathode included in a lithium ion cell. In this example, during charging of the lithium ion cell, first active material particles 240 delithiate. During this process, the active material particles may contract, causing active material layer 202 to contract. In contrast, during discharging of the cell, the active material particles lithiate and swell, causing active material layer 202 to swell.

In an alternate example, electrode 200 is a portion of an anode included in a lithium ion cell. In this example, during charging of the lithium ion cell, first active material particles 240 lithiate. During this process, the active material particles may swell, causing active material layer 202 to swell. In contrast, during discharging of the cell, first active material particles 240 delithiate and contract, causing contraction of active material layer 202.

In either of these examples, during swelling and contracting, electrode 200 may remain coherent, and active material layer 202 and separator layer 204 remain bound by interlocking region 210. This bonding of the active material layer and separator layer may decrease interfacial resistance between the layers and maintain mechanical integrity of an electrochemical cell including the electrode.

Interlocking region 210 may comprise a network of fluid passageways defined by active material particles, nitrides, disordering particles, binder, conductive additives, and/or additional layer components. These fluid passages are not hampered by calendering-induced changes in mechanical or morphological state of the particles due to the non-planar boundary included in the interlocking region. In contrast, a substantially planar boundary is often associated with pulverization of surface particles upon subsequent calendering. Such particle pulverization is disadvantageous as it can significantly impede ion conduction through the interlocking region. Furthermore, such particle pulverization also represents a localized compaction of active material particles that effectively result in reduced pore volumes within the electrode. This may be an issue of particular importance for anodes, as solid electrolyte interphase (SEI) film buildup on active material particles clogs pores included within the electrode at a quicker rate, leading to lithium plating, decreasing safety and cycle life of the electrode.

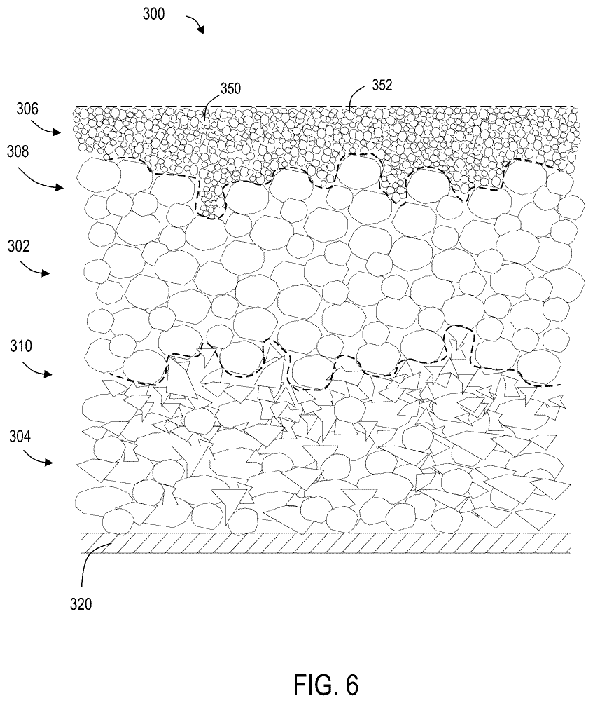

In some examples, an electrode including an integrated separator may include two or more active material layers. FIG. 6 is an illustrative multi-layered electrode 300 including a first active material layer 302, a second active material layer 304, and a separator layer 306. Second active material layer 304 may be disposed adjacent to a current collector substrate 320. First active material layer 302 may be layered on top of second active material layer 304. Separator layer 306 may be layered on top of first active material layer 302. First active material layer 302 may include a plurality of first active material particles adhered together by a first binder. Second active material layer 304 may include a plurality of second active material particles adhered together by a second binder. The first and second active material particles may be substantially similar to active material particles 240, described above. Separator layer 306 may include a plurality of nitride particles 350 and a plurality of disordering particles 352 adhered together by a third binder. Nitride particles 350 and disordering particles 352 may be substantially similar to nitride particles 250 and disordering particles 252, described above.

A first interlocking region 308 is formed between separator layer 306 and first active material layer 302. A second interlocking region 310 is formed between first active material layer 302 and second active layer 304. First interlocking region 308 and second interlocking region 310 may be substantially identical to interlocking region 210, as described above.

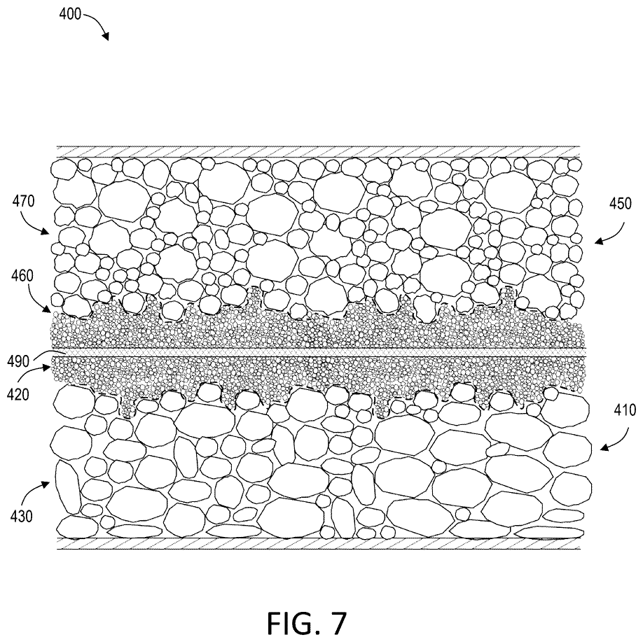

In some examples, electrodes including integrated separators, such as electrodes 200 and 300, are included in electrochemical cells. Illustrative electrochemical cells including electrodes including integrated separators are illustrated in FIGS. 7-9, which are described in more detail below.

FIG. 7 shows an electrochemical cell 400 including an anode 410 having a first integrated separator 420 and a cathode 450 having a second integrated separator 460. A polyolefin separator 490 is disposed between anode 410 and cathode 450. Anode 410 and/or cathode 450 may be substantially identical to either single-layered electrode 200 or multilayered electrode 300, described above. Accordingly, in some examples, either and/or both of first integrated separator 420 and second integrated separator 460 comprise a mixture of nitride particles, such as hexagonal-boron nitride particles, and disordering particles, such as alumina particles, as described above with respect to electrode 200.

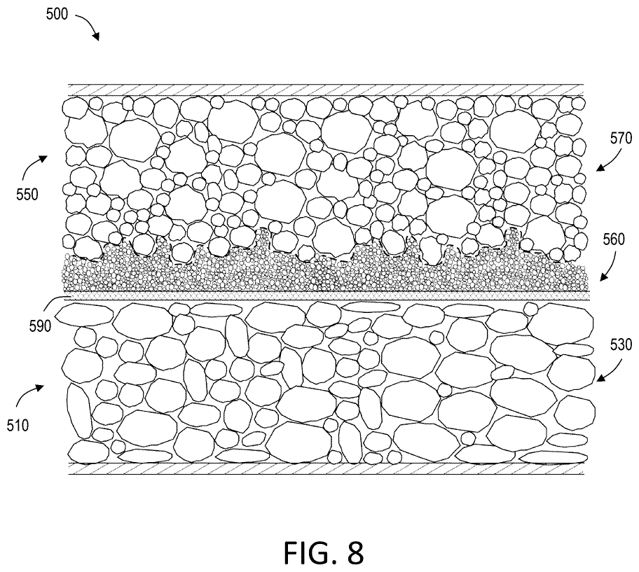

In some examples, an electrochemical cell including an integrated separator may have a separator included in either a positive electrode or a negative electrode. In a first example, the electrochemical cell includes an integrated separator included in a cathode. FIG. 8 shows an electrochemical cell 500 including an anode 510, and a cathode 550 having an integrated separator 560. A polyolefin separator 590 is disposed between anode 510 and cathode 550. Cathode 520 may be substantially identical to either single-layered electrode 200 or multilayered electrode 300, described above. Accordingly, integrated separator 560 may comprise a mixture of nitride particles, such as hexagonal-boron nitride particles, and disordering particles, such as alumina particles, as described above with respect to electrode 200.

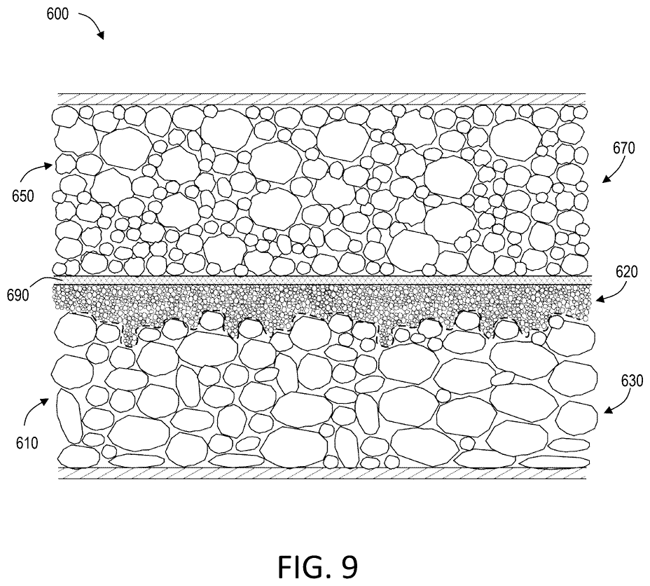

In some examples, an electrochemical cell including an integrated separator may have a separator included in an anode. FIG. 9 shows an electrochemical cell 600 including an anode 610 having an integrated separator 620 and a cathode 650. A polyolefin separator 690 is disposed between anode 610 and cathode 650. Anode 610 may be substantially identical to either single-layered electrode 200 or multilayered electrode 300, described above. Accordingly, integrated separator 620 may comprise a mixture of nitride particles, such as hexagonal-boron nitride particles, and disordering particles, such as alumina particles, as described above with respect to electrode 200.

In some examples, electrochemical cells including integrated separators may include a negative electrode (anode) having a first integrated separator and a positive electrode (cathode) having a second integrated separator disposed adjacent to each other, such that the first integrated separator and the second integrated ceramic separator are directly in contact with each other. This configuration may result in a low impedance electrochemical cell.

### C. Illustrative Electrochemical Cell Having Integrated Separator

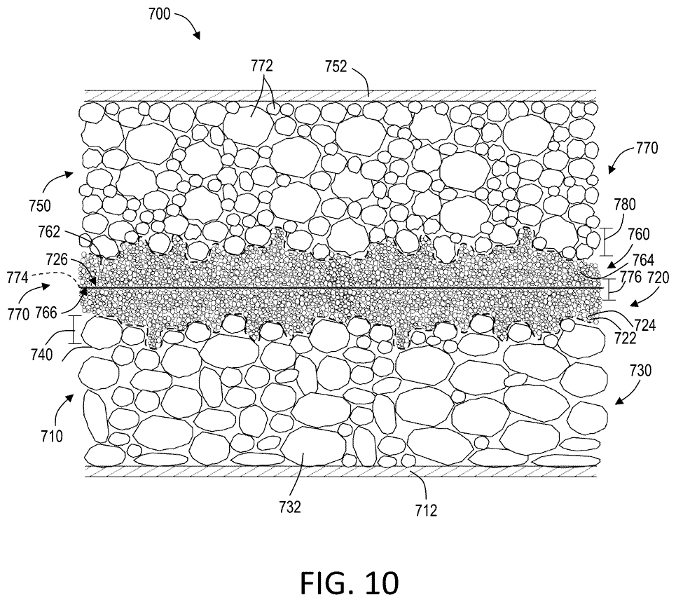

FIG. 10 depicts an electrochemical cell 700 including a unified integrated separator 770. Electrochemical cell 700 includes an anode 710 having a first integrated separator 720 and a cathode 750 having a second integrated separator 760. First integrated separator 720 and second integrated separator 760 collectively form unified integrated separator 770. Anode 710 and cathode 750 may be substantially identical to either single-layered electrode 200 or multilayered electrode 300, described above. While, in some examples, first integrated separator 720 and second integrated separator 760 may have different compositions, first integrated separator 720 and second integrated separator 760 are bonded together to form a single unified integrated separator 770.

Anode 710 is disposed upon and in contact with a first current collector 712. First current collector 712 may include metal foils such as copper and/or any suitable substrate, and may be electrically coupled to anode 710.

Anode 710 may include a first active material layer 730 and a first separator layer 720, with active material layer 730 including a plurality of active material particles 732 adhered together by a first binder, and first separator layer 720 including a plurality of first inorganic particles 724 adhered together by a second binder. In some examples, either and/or both of first integrated separator 720 and second integrated separator 760 comprise a mixture of nitride particles, such as hexagonal-boron nitride particles, and disordering particles, such as alumina particles, as described above with respect to electrode 200. Accordingly, in some examples, first inorganic particles 721 include a plurality of nitride particles 722 and a plurality of disordering particles 724 adhered together by a second particles. In some examples, anode 710 may further include an additional active material layer disposed between first active material layer 730 and first separator layer 720. In some examples, the second and additional active material layers may include an interlocking region 740 disposed between them. The interlocking region may be substantially identical to interlocking region 310 described above. Anode active material particles 732 may comprise graphite (artificial or natural), hard carbon, soft carbon, titanate, titania, transition metals in general, elements in group 14 (e.g., carbon, silicon, tin, germanium, etc.), oxides, sulfides, transition metals, halides, and/or chalcogenides.

Nitride particles 722 may comprise any suitable material, such as hexagonal-boron nitride, aluminum nitride, and/or the like. Disordering particles 724 may comprise any suitable inorganic material or materials, including ceramics such as aluminum oxide (i.e., alumina (α-Al₂O₃)), corundum, calcined, tabular, synthetic boehmite, silicon oxides or silica, zirconia, and/or the like. Disordering particles 724 may be electrically non-conductive. In some examples, disordering particles 724 may have a D50 between 100 nm and 10 μm. In some examples, integrated separator 720 is substantially identical to integrated separator 204. However, in some examples, integrated separator 720 comprises a plurality of first ceramic particles 721 adhered together by the third binder (i.e., in some examples, integrated separator 720 does not comprise nitride particles 722).

A first interlocking region 740 may be disposed between first active material layer 730 and first separator layer 720. First interlocking region 740 may be substantially identical to interlocking region 210 of illustrative electrode 200, described above. Anode 710 may be optionally calendered to provide a flat surface at a top surface 726 of first separator layer 720.

Cathode 750 is disposed upon and in contact with anode 710. Cathode 750 may include a second active material layer 770 and a second separator layer 760, with active material layer 770 including a plurality of active material particles 772 adhered together by a first binder, and separator layer 760 including a plurality of second inorganic particles 764 adhered together by a second binder. In some examples, separator layer 760 includes a plurality of nitride particles 762 and a plurality of disordering particles 764 adhered together by a second particles. In some examples, cathode 750 may further include an additional active material layer disposed between second active material layer 770 and second separator layer 760. In some examples, the second and additional active material layers may include an interlocking region disposed between them. The interlocking region may be substantially identical to interlocking region 310 described above. Cathode active particles 772 may comprise transition metals (for example, nickel, cobalt, manganese, copper, zinc, vanadium, chromium, iron), and/or their oxides, phosphates, phosphites, and/or silicates. In some examples, the cathode active material particles may include alkalines and alkaline earth metals, aluminum, aluminum oxides and aluminum phosphates, halides and/or chalcogenides.

Nitride particles 762 may comprise any suitable material, such as hexagonal-boron nitride, aluminum nitride, and/or the like. Disordering particles 764 may comprise any suitable inorganic material or materials, including ceramics such as aluminum oxide (i.e., alumina (α-Al₂O₃)), corundum, calcined, tabular, synthetic boehmite, silicon oxides or silica, zirconia, and/or the like. Disordering particles 764 may be electrically non-conductive. In some examples, disordering particles 764 may have a D50 between 100 nm and 10 μm. In some examples, integrated separator 760 is substantially identical to integrated separator 204. However, in some examples, second integrated separator 760 comprises a plurality of ceramic particles 761 adhered together by the third binder (i.e., in some examples, second integrated separator 760 does not comprise nitride particles 762).

A second interlocking region 780 may be disposed between second active material layer 770 and second separator layer 760. Second interlocking region 780 may be substantially identical to interlocking region 210 of illustrative electrode 200, described above. Cathode 750 may be optionally calendered to provide a flat surface at a bottom surface 766 of separator layer 760. In some examples, bottom surface 766 may contact top surface 726 of anode 710, resulting in two ceramic separator layers having calendered surfaces disposed between them.

A second current collector 752 is disposed on and in contact with cathode 750. Second current collector 752 may include metal foils such as aluminum and/or any suitable substrate and may be electrically coupled to cathode 750.

In some examples, electrochemical cell 700 includes a single unified separator layer 770 interlocked with both anode 710 and cathode 750. Accordingly, first integrated separator layer 720 is bonded to second integrated separator layer 760, thereby forming a single separator layer 770, wherein the first integrated separator layer is substantially indistinguishable from the second separator layer. In some examples, electrochemical cell 700 further comprises a third integrated separator layer 772 disposed at the interface between first integrated separator layer 720 and second integrated separator layer 770. In some examples, the third integrated separator layer 772 comprises a third plurality of ceramic particles adhered together by a binder having a greater strength, greater concentration, and/or different compositions than the first integrated separator layer and/or the second integrated separator layer. In some examples, methods of unifying the first integrated separator layer and the second integrated separator layer cause visible changes within the microstructure of the unified separator layer. Accordingly, in some examples, a porosity of the unified separator layer may be greater in regions of the unified separator layer corresponding to a separator interface 774 between the first integrated separator layer and the second integrated separator layer due to plasticizing solvents applied at the separator interface. In some examples, a porosity of the unified separator layer may be lower in regions of the unified separator layer corresponding to the separator interface due to tailored crosslinking performed at the separator interface. In some examples, the unified separator layer comprises a tailored porosity gradient comprising regions of high porosity and regions of low porosity configured to maximize a surface area of the separator interface while retaining an ion permeability of the unified separator layer.

In some examples, the unified separator layer comprises a polymerization region 776 disposed at the separator interface. In some examples, the polymerization region corresponds to a region of increased crosslinking configured to bond the first integrated separator layer to the second integrated separator layer. In some examples, the first integrated separator layer and/or the second integrated separator layer are configured to induce polymerization upon contact. Accordingly, in some examples, one of the first integrated separator layer and the second integrated separator layer includes oligomers and/or monomers and the other one of the first integrated separator layer includes an activating substance configured to initiate polymerization. Upon stacking of the first electrode and the second electrode, polymerization is induced at the separator interface. In some examples, the activating substance comprises a polymeric initiator such as an azo initiator, a peroxide initiator, and/or the like. In some examples, the activating substance comprises a pH-mediating substance such as oxalic acid, boronic acid, and/or the like.

### D. Illustrative Electrode Manufacturing Method

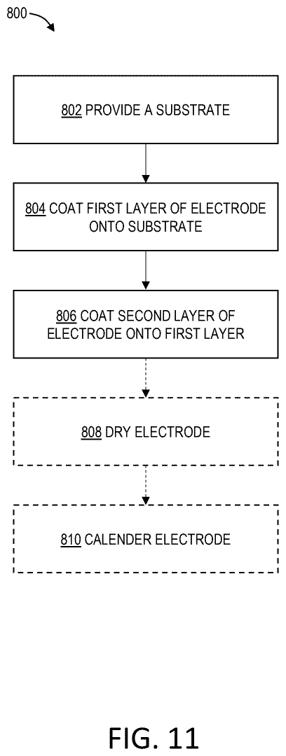

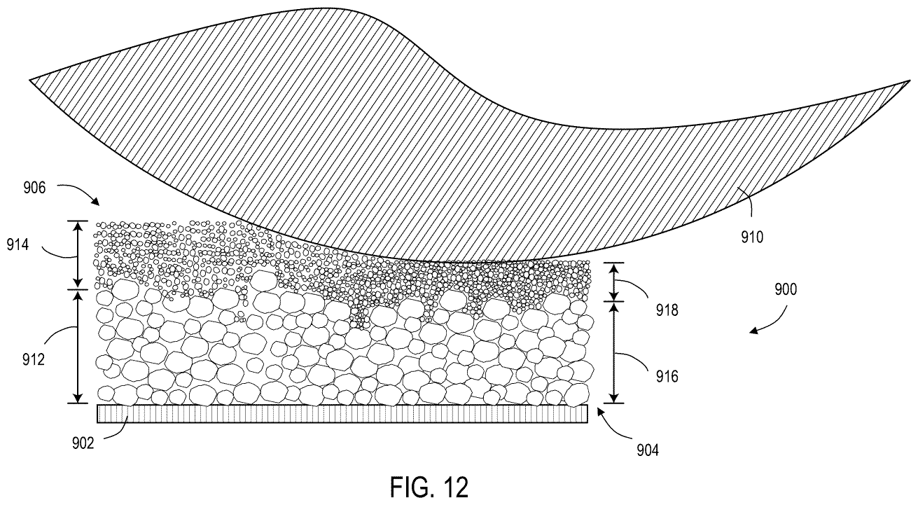

The following describes steps of an illustrative method 800 for forming an electrode including an integrated separator layer; see FIGS. 11-12.

Aspects of electrodes and manufacturing devices described herein may be utilized in the method steps described below. Where appropriate, reference may be made to components and systems that may be used in carrying out each step. These references are for illustration, and are not intended to limit the possible ways of carrying out any particular step of the method.

FIG. 11 is a flowchart illustrating steps performed in an illustrative method, and may not recite the complete process or all steps of the method. Although various steps of method 800 are described below and depicted in FIG. 11, the steps need not necessarily all be performed, and in some cases may be performed simultaneously, or in a different order than the order shown.

Step 802 of method 900 includes providing a substrate, wherein the substrate includes any suitable structure and material configured to function as a conductor in a secondary battery of the type described herein. In some examples, the substrate comprises a current collector. In some examples, the substrate comprises a metal foil. The term “providing” here may include receiving, obtaining, purchasing, manufacturing, generating, processing, preprocessing, and/or the like, such that the substrate is in a state and configuration for the following steps to be carried out.

Method 800 next includes a plurality of steps in which at least a portion of the substrate is coated with an electrode material composite. This may be done by causing a current collector substrate and an electrode material composite dispenser to move relative to each other, by causing the substrate to move past an electrode material composite dispenser (or vice versa) that coats the substrate as described below. The composition of material particles in each electrode material composite layer may be selected to achieve the benefits, characteristics, and results described herein. The electrode material composite may include one or more electrode layers, including a plurality of active material particles, and one or more separator layers, each including a plurality of inorganic material particles.

Step 804 of method 800 includes coating a first layer of a composite electrode on a first side of the substrate. In some examples, the first layer may include a plurality of first particles adhered together by a first binder, the first particles having a first average particle size (or other first particle distribution). In some examples, the plurality of first particles may comprise a plurality of first active material particles. In some examples, the composite electrode is an anode suitable for inclusion within an electrochemical cell. In this case, the first particles may comprise graphite (artificial or natural), hard carbon, soft carbon, titanate, titania, transition metals in general, elements in group 14 (e.g., carbon, silicon, tin, germanium, etc.), and their oxides, phosphates, phosphites, silicates, alkalines and alkaline earth metals, aluminum, aluminum oxides and aluminum phosphates, halides, chalcogenides, and/or the like. In some examples, the first active material particles comprise transition metal oxides, such as nickel manganese cobalt oxide (NMC), lithium cobalt oxide (LCO), lithium iron phosphate (LFP), and/or the like. In some examples, the first binder is a polymer, e.g., polyvinylidene difluoride (PVdF), Teflon (PTFE), and/or the like. In some examples, the first layer further includes first conductive additives comprising nanometer-sized carbons, such as carbon black, carbon nanotubes, micron-sized carbon (e.g., flake graphite), and/or the like.

The coating process of step 804 may include any suitable coating method(s), such as slot die, blade coating, spray-based coating, electrostatic jet coating, or the like. In some examples, the first layer is coated as a wet slurry of solvent, e.g., water or NMP (N-Methyl-2-pyrrolidone), binder, conductive additive, and active material. In some examples, the first layer is coated dry, as an active material with a binder and/or a conductive additive. In some examples, coating the first layer dry includes spraying the dry coating onto the substrate using any suitable method, such as electrostatically spraying, particle coating, high-velocity spraying, and/or the like. Step 804 may optionally include drying the first layer of the composite cathode. Step 804 may optionally include drying the first layer of the composite electrode.

Step 806 of method 800 includes coating a second layer onto the first layer, forming a multilayered (e.g., stratified) structure. The second layer may include a plurality of second particles adhered together by a second binder, the second particles having a second average particle size (or other second particle distribution). In this example, the second layer comprises particles configured to function as a separator for the electrode. For example, the second layer may comprise ceramic particles, such as aluminum oxide (i.e., alumina (α-Al₂O₃)), corundum, calcined, tabular, synthetic boehmite, silicon oxides or silica, zirconia, and/or the like. In some examples, the second layer comprises a mixture of nitride particles, such as hexagonal-boron nitride particles, and disordering particles, such as alumina particles, as described above with respect to electrode 200.

In some examples, steps 804 and 806 may be performed substantially simultaneously. For example, both of the slurries may be extruded through their respective orifices simultaneously. This forms a two-layer slurry bead and coating on the moving substrate. In some examples, difference in viscosities, difference in surface tensions, difference in densities, difference in solids contents, and/or different solvents used between the first active material slurry and the second separator slurry may be tailored to cause interpenetrating finger structures at the boundary between the two composite layers. In some examples, the viscosities, surface tensions, densities, solids contents, and/or solvents may be substantially similar. Creation of interpenetrating structures, if desired, may be facilitated by turbulent flow at the wet interface between the first active material slurry and the second separator slurry, creating partial intermixing of the two slurries.

To facilitate proper curing in the drying process, the first layer (closest to the current collector) may be configured (in some examples) to be dried from solvent prior to the second layer (further from the current collector) so as to avoid creating skin-over effects and blisters in the resulting dried coatings.

In some examples, any of the described steps may be repeated to form three or more layers. For example, an additional layer or layers may include active materials to form a multilayered electrode structure before adding the separator layer. Any method described herein to impart structure between the first active material layer and the separator coating may be utilized to form similar structures between any additional layers deposited during the manufacturing process. In some examples, a first composite electrode layer, a second composite electrode layer, and a third composite electrode layer may be extruded simultaneously. The first composite electrode layer and the second composite electrode layer may comprise first and second active material particles, while the third composite electrode layer may comprise inorganic particles (e.g., ceramic particles, nitride particles, disordering particles), such as in an integrated separator layer. Simultaneous extrusion of three slurries may form a three-layer slurry bead on the moving substrate. Interpenetrating finger structures may form at a boundary between the first composite electrode layer and the second composite electrode layer, as well as between the second composite electrode layer and the third composite electrode layer.

Method 800 may further include drying the composite electrode in step 808, and/or calendering the composite electrode in step 810. Both the first and second layers may experience the drying process and the calendering process as a combined structure. In some examples, step 808 may be combined with calendering (e.g., in a hot roll process). In some examples, drying step 808 includes a form of heating and energy transport to and from the electrode (e.g., convection, conduction, radiation) to expedite the drying process. In some examples, calendering is replaced with another compression, pressing, or compaction process. In some examples, calendering the electrode in step 810 may be performed by pressing the combined first and second layers against the substrate, such that electrode density is increased in a non-uniform manner, with the first layer having a first porosity and the second layer having a lower second porosity.

FIG. 12 shows an electrode undergoing the calendering process, in which particles in a second layer 906 (AKA the separator layer) can be calendered with a first layer 904 (AKA the active material layer). This may prevent particle pulverization within the electrode, specifically on the active material layer. A roller 910 may apply pressure to a fully assembled electrode 900. Electrode 900 may include first layer 904 and second layer 906 applied to a substrate web 902. First layer 904 may have a first uncompressed thickness 912 and second layer 906 may have a second uncompressed thickness 914 prior to calendering. After the electrode has been calendered, first layer 904 may have a first compressed thickness 916 and second layer 906 may have a second compressed thickness 918. In some examples, second layer 906 may have a greater resistance to densification and a lower compressibility than first layer 904. After a certain level of densification, a higher tolerance to bulk compression of the separator layer may transfer a load to the more compressible electrode layer below. This process may effectively densify the electrode without over densifying the separator layer.

### E. Illustrative Electrode Manufacturing Systems

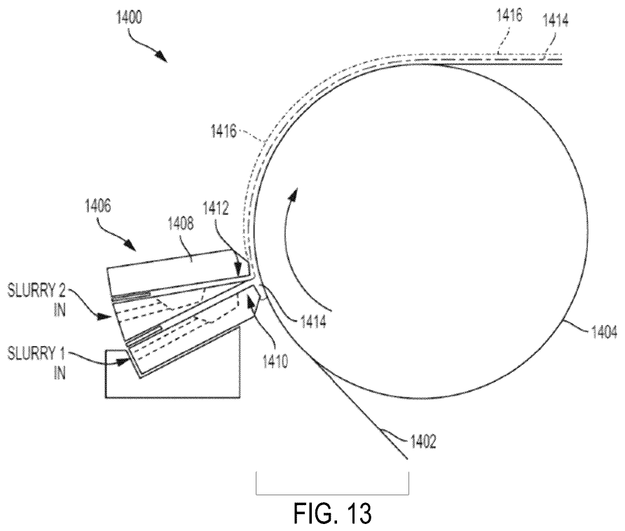

Turning to FIG. 13, an illustrative manufacturing system 1400 for use with method 800 will now be described. In some examples, a slot-die coating head with at least two fluid slots, fluid cavities, fluid lines, and fluid pumps may be utilized to manufacture a battery electrode featuring an active material layer and an integrated separator layer (AKA a separator coating). In some examples, additional cavities may be utilized to create additional active material layers (e.g., in an electrochemical cell including two active material layers and one integrated separator layer).

In system 1400, a foil substrate 1402 is transported by a revolving backing roll 1404 past a stationary dispenser device 1406. Dispenser device 1406 may include any suitable dispenser configured to evenly coat one or more layers of slurry onto the substrate. In some examples, the substrate may be held stationary while the dispenser head moves. In some examples, both may be in motion. Dispenser device 1406 may, for example, include a dual chamber slot die coating device having a coating head 1408 with two orifices 1410 and 1412. A slurry delivery system may supply two different slurries to the coating head under pressure. Due to the revolving nature of backing roll 1404, material exiting the lower orifice or slot 1410 will contact substrate 1402 before material exiting the upper orifice or slot 1412. Accordingly, a first layer 1414 will be applied to the substrate and a second layer 1416 will be applied on top of the first layer. In the present disclosure, the first layer 1414 may be the active material of an electrode and the second layer may be a separator layer.

Manufacturing method 900 may be performed using a dual-slot configuration, as described above, to simultaneously extrude the electrode material and the separator layers, or a multi-slot configuration with three or more dispensing orifices utilized to simultaneously extrude a multilayered electrode with an integrated separator layer. In some examples, manufacturing system 1400 may include a tri-slot configuration, such that a first active material layer, a second active material layer, and the separator layer may all be extruded simultaneously. In another example, the separator layer may be applied after the electrode (single layered or multilayered) has first dried.

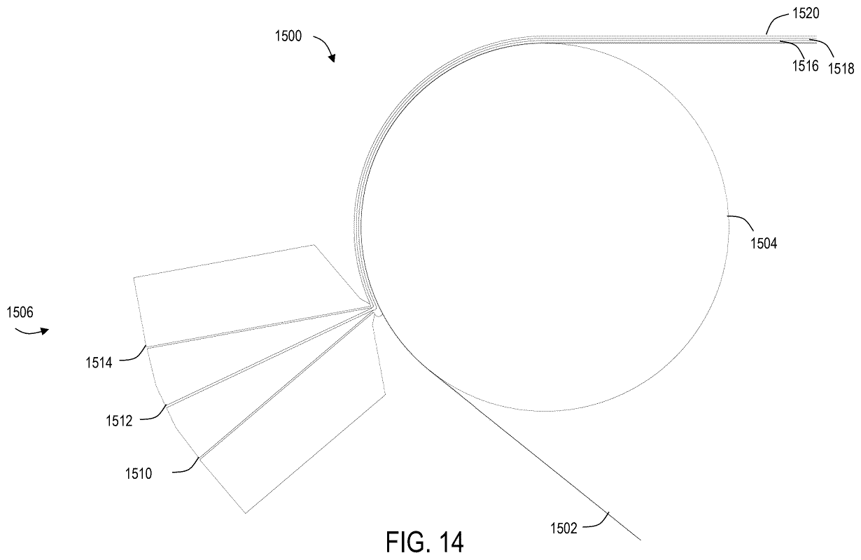

Turning now to FIG. 14, manufacturing system 1500 is depicted, which includes a tri-slot configuration, such that the first layer, the second layer, and a third electrode layer (e.g., an integrated porous separator layer, a carbon conductive layer, a third active material layer, a protective strip, etc.) may all be extruded simultaneously. In manufacturing system 1500, a foil substrate 1502 is transported by a revolving backing roll 1504 past a stationary dispenser device 1506. Dispenser device 1506 may include any suitable dispenser configured to evenly coat one or more layers of slurry onto the substrate. In some examples, the substrate may be held stationary while the dispenser head moves. In some examples, both the substrate and the dispenser head may be in motion. Dispenser device 1506 may, for example, include a three-chamber slot die coating device having a coating head 1508 with three orifices 1510, 1512, and 1514. A slurry delivery system may supply three different slurries to the coating head under pressure. Due to the revolving nature of backing roll 1504, material exiting the lower orifice or slot 1510 will contact substrate 1502 before material exiting the central orifice or slot 1512. Similarly, material exiting central orifice or slot 1512 will contact material exiting lower orifice or slot 1510 before material exiting upper orifice or slot 1514. Accordingly, a first layer 1516 will be applied to the substrate, a second layer 1518 will be applied on top of the first layer, and a third layer 1520 will be applied on top of the second layer.

In some examples, the three orifices may have different widths, such that the dispenser device is configured to apply layers having different widths. For example, in methods of manufacturing of cathodes having a protective strip, the protective strip may be simultaneously dispensed with electrode and/or separator layers, but may have a width less than a width of the electrode and/or separator layers.

### F. Illustrative Method of Insulating Cathode Tabs

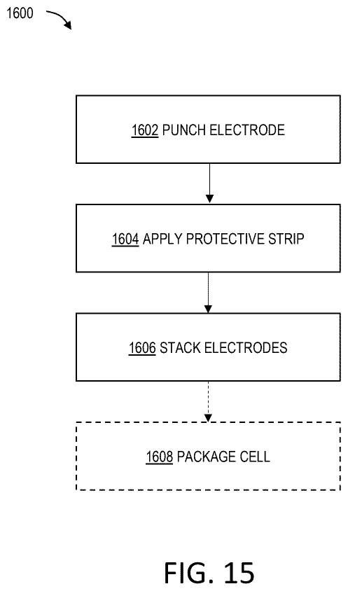

The following describes steps of an illustrative method 1600 for insulating tabs of a cathode, see FIGS. 15-19.

Aspects of electrodes 200 and 300 and manufacturing devices 1400 and 1500 described herein may be utilized in the method steps described below. Where appropriate, reference may be made to components and systems that may be used in carrying out each step. These references are for illustration, and are not intended to limit the possible ways of carrying out any particular step of the method.

FIG. 15 is a flowchart illustrating steps performed in an illustrative method, and may not recite the complete process or all steps of the method. Although various steps of method 1600 are described below and depicted in FIG. 15, the steps need not necessarily all be performed, and in some cases may be performed simultaneously, or in a different order than the order shown.

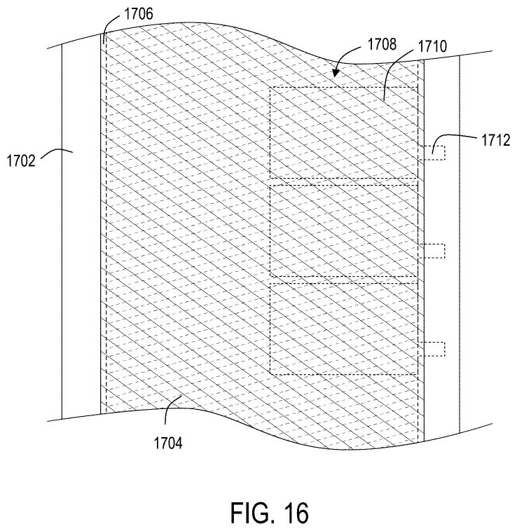

Step 1602 of method 1600 includes punching a cathode from a substrate. Electrodes, such as cathodes, according to the present teachings are generally manufactured in a reel-to-reel process, producing a continuous sheet of electrode material. To produce a stacked cell, individual electrodes are punched (e.g., with a die, punch, machining tool, and/or the like) from the substrate. FIG. 16 depicts a substrate web 1702 having an electrode layer 1704 applied directly to the substrate web and a separator layer 1706 disposed on top of the electrode layer. The electrode layer may comprise one active material layer or two or more active material layers. The layers disposed on the substrate in this manner facilitate electrode blanking, in which the conductive substrate, electrode layer, and separator layer may be cut from the web in one piece. An electrode cut in this example of the manufacturing method may have a shape 1708, including an electrode body 1710 and tab 1712. This may allow for a simpler manufacturing process and further reduce cost of manufacturing electrodes.

However, punching a cathode from a substrate may produce burrs or other irregularities around edges of the punched cathode. More specifically, punching the cathode may cause burrs to form at edges of the current collector substrate, which typically comprises a metal foil. Burrs or other irregularities may cause shorting when the burrs of the cathode current collector contact an anode or anode current collector when the electrode stack is assembled. Burrs are particularly problematic when disposed at tab regions of the cathode, as electrode tabs are free from insulating coatings, such as integrated separators described herein. In cathodes including integrated separators, the integrated separator may wrap around edges of the electrode layers and current collector substrates, insulating the cathode from the anode. However, tabs of the cathode comprise bare current collector substrate (i.e., not insulated by electrode or separator layers). Accordingly, insulating the tabs of the cathode with a protective strip may prevent shorting between the anode and the cathode in locations where the cathode tab overlaps with the anode edge.

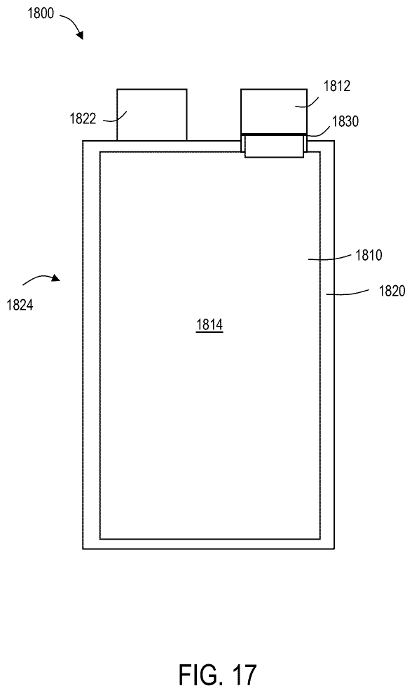

FIG. 17 depicts an electrochemical cell 1800 including a cathode 1810 and an anode 1820. As is visible in FIG. 17, an anode body 1824 generally has a larger surface area than a cathode body 1814 to prevent shorting between the anode and cathode at ends of the electrode opposite tabs 1812, 1822. Accordingly, a portion of cathode tab 1812 overlaps with a portion of anode body 1824, causing shorting between the cathode and the anode at short location 1830.

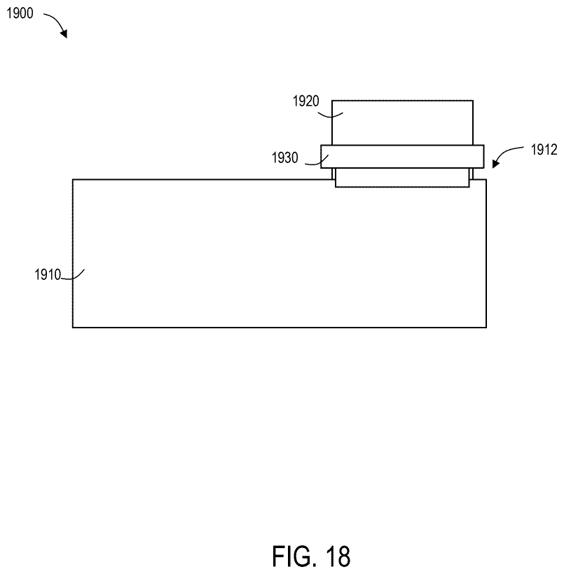

Step 1604 of method 1600 includes applying a protective strip to a junction between the cathode tab and the cathode body. Specifically, insulating the tab with a strip of polymer or wax insulates the cathode tab from the anode. In some examples, the protective strip comprises a polymer, such as polypropylene, polyethylene, polyimine, polyethylene terephthalate, etc., a wax, such as paraffin, polyethylene, Fischer Tropsch, stearic acid, etc., and/or the like. The protective strip may be applied at any suitable stage of cell manufacturing, such as before punching or after punching. FIG. 18 depicts an illustrative cathode 1900 including a protective strip 1930 applied to the junction 1912 between cathode body 1910 and cathode tab 1920.

In some examples, the protective strip is applied to the cathode before punching (i.e., before step 1602). Accordingly, in some examples, the protective strip is applied in a slurry bead using any suitable method, such as spraying, coating, and/or the like. In some examples, the protective strip is manufactured substantially simultaneously with the cathode, such as by a multi-orificed slot die dispenser depositing the cathode composite. In these examples, the protective strip may have a width less than other layers dispensed by the multi-orificed slot die dispenser, such that the protective strip insulates the junction between the cathode tab and the cathode body.

In some examples, a method of applying the protective strip to the cathode tab comprises extruding or laminating the protective strip onto an intersection region between the cathode tab and the anode. In some examples, extruding or laminating the protective strip onto the intersection point includes utilizing a lamination machine typically utilized in manufacturing and/or sealing electrode packaging to apply the protective strip to the intersection region.

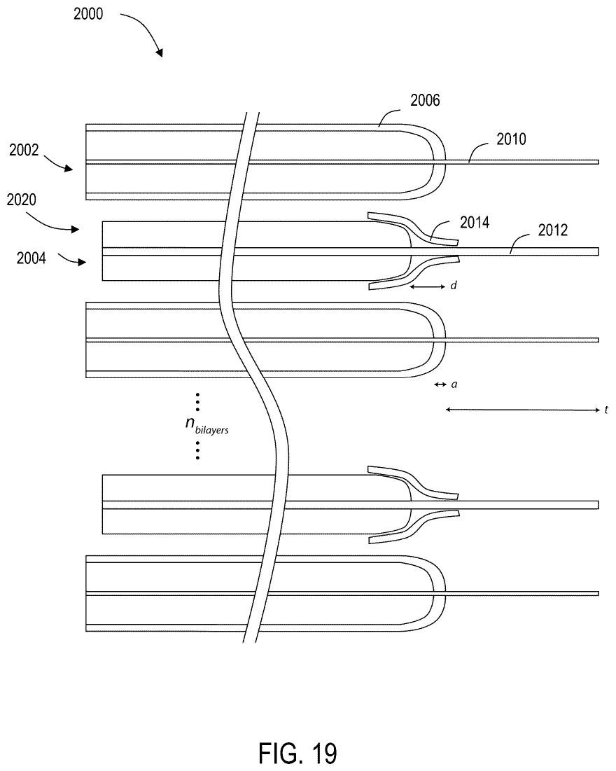

Step 1606 of method 1600 includes stacking the cathode with one or more anodes and, optionally, one or more cathodes to form an electrode stack. FIG. 19 shows a stacked cell configuration 2000 having tabs 2010 and 2012 protruding from an anode 2002 and a cathode 2004 respectively, in a bilayer cell 2020. One or both of anode 2002 and cathode 2004 may be multi-layered, similar to electrode 300 of FIG. 5. Tab 2010, in the present example, may protrude from anode 2002, passing through electrode layer 2005 and separator layer 2006. A thicker separator layer 2006 on the distal end of the electrode where the tab protrudes may prevent shorting between anode 2002 and cathode 2004. Protective strips 2014 may be applied to cathode 2004 and tab 2012 at the distal end of the electrode, further adding insulation and preventing shorting between anode 2002 and cathode 2004.

Step 1608 of method 1600 includes optionally packaging the electrochemical cell. Packaging the electrochemical cell may include inserting the cell into a can, as with a wound cell, inserting the cell into a pouch bag, as with a pouch cell, and/or any other suitable method of packaging an electrochemical cell such as a lithium-ion battery. In some examples, optionally packaging the electrochemical cell includes sealing the pouch bag with a laminator utilized to apply the protective strip.

### G. Illustrative Method of Manufacturing an Electrochemical Cell

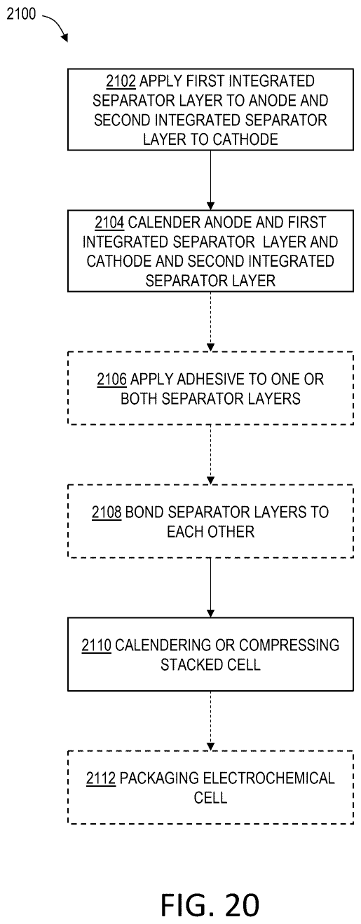

This section describes steps of an illustrative method 2100 for manufacturing electrochemical cells including integrated ceramic separators; see FIG. 20. Aspects of electrodes 200 and 300, electrochemical cells 400, 500, 600, and 700 and methods for manufacturing 800 and 1600 may be utilized in the method steps described below. Where appropriate, reference may be made to components and systems that may be used in carrying out each step. These references are for illustration, and are not intended to limit the possible ways of carrying out any particular step of the method.

FIG. 20 is a flowchart illustrating steps performed in an illustrative method, and may not recite the complete process or all steps of the method. Although various steps of method 2100 are described below and depicted in FIG. 20, the steps need not necessarily all be performed, and in some cases may be performed simultaneously or in a different order than the order shown.

Step 2102 of method 2100 includes applying a first integrated separator layer to an anode of an electrochemical cell and a second integrated separator to a cathode of an electrochemical cell. The first and second integrated separator may be applied using any suitable method, such as method 800, described above. In some examples, the first integrated separator layer is applied to the anode and the second integrated separator layer is applied to the cathode simultaneously (e.g., using manufacturing system 1400, 1500, as described above). In some examples, the first and second integrated separator layers are applied to the anode and the cathode while the anode and cathode are wet (i.e., before drying of the electrode layers). In some examples, either and/or both of the anode and the cathode comprise multiple electrode layers, as in electrode 300. The first and second integrated separator layers may have any suitable composition, such as comprising an integrated ceramic separator layer comprising a plurality of ceramic particles, such as aluminum oxide (i.e., alumina (α-Al₂O₃)), corundum, calcined, tabular, synthetic boehmite, silicon oxides or silica, zirconia, and/or the like mixed with a binder. In some examples, the first and/or second integrated separator layers comprise a mixture of nitride particles, such as hexagonal-boron nitride particles, and disordering particles, such as alumina particles, as described above with respect to electrode 200 mixed with a binder. In some examples, the first and second integrated separator layers have a same composition. In some examples, the first and second integrated separator layers comprise different materials. In some examples, step 2102 of method 2100 is substantially identical to step 806 of method 800, except as otherwise described.

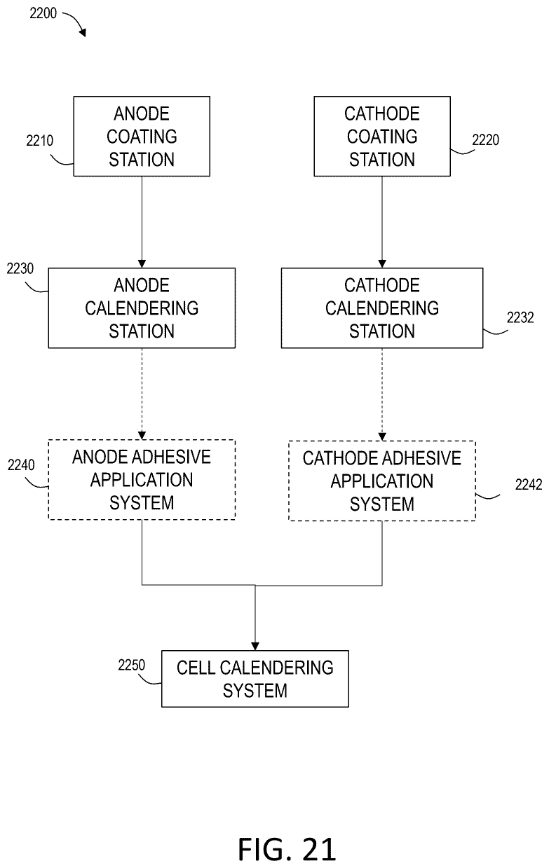

FIG. 21 is a schematic depicting an illustrative manufacturing system 2200 configured for use in method 2100. As depicted in FIG. 21, illustrative manufacturing system 2200 includes an anode coating station 2210, wherein an anode is coated with a first separator layer. Similarly, illustrative manufacturing system 2200 includes a cathode coating station 2220, wherein a cathode is coated with a second separator. In some examples, anode coating station 2210 and cathode coating station 2220 are substantially identical to manufacturing systems 1400 and/or 1500, as described above.

Step 2104 of method 2100 includes calendering the anode and the first integrated separator layer as a unit and calendering the cathode and the second integrated separator layer as a unit. In some examples, calendering the anode and the first integrated separator layer as a unit and calendering the cathode and the second integrated separator layer as a unit is substantially similar to the process depicted in FIG. 10. In some examples, step 2104 of method 2100 includes partially calendering each electrode, such that a total thickness of each electrode after step 2104 is greater than a final thickness of each electrode. In some examples, step 2104 of method 2100 includes fully calendering each electrode, such that a thickness and density of each electrode after step 2104 is substantially equal to a final thickness of each electrode. Calendering the cathode and the anode may be performed by anode calendering system 2230 and cathode calendering system 2232. In some examples, anode calendering system 2230 and cathode calendering system 2232 are substantially identical to roller 910, described above. In some examples, anode 2202 and cathode 2206 are each coated on both sides of a current collector substrate, such that adjacent anodes and cathodes share anode current collectors and cathode current collectors. Accordingly, anode calendering system 2230 and cathode calendering system 2232 respectively comprise a pair of rollers.

In some examples, step 2106 of method 2100 further comprises optionally applying adhesive to a top surface of either and/or both of the first integrated separator layer and the second integrated separator layer. The adhesive may be applied using any suitable method, such as spraying, brushing, rolling, screen printing, extruding (e.g., through a slot die applicator), transfer printing, curtain coating, thin film deposition, and/or the like. In some examples, adhesive is applied to either and/or both of the first integrated separator layer and the second integrated separator layer by anode adhesive application system 2240 and/or cathode adhesive application system 2242. Anode adhesive application 2240 and cathode adhesive application system 2242 may comprise any suitable systems for applying adhesive, such as sprayers, brushes, rollers, slot die applicators, and/or the like.

Step 2108 of method 2200 includes bonding a first integrated separator layer comprising a first plurality of inorganic particles to a second integrated separator layer comprising a second plurality of inorganic particles, thereby forming a single separator layer, wherein the first integrated separator layer is substantially indistinguishable from the second separator layer. In some examples, step 2108 comprises adhering the first integrated separator layer to the second integrated separator method utilizing adhesive applied in step 2106.

In some examples, methods of bonding a first integrated separator layer to a second integrated separator layer comprise applying a plasticizing solvent to a separator interface between the first integrated separator layer and the second integrated separator layer, thereby increasing a plasticity of the first integrated separator layer and/or the second integrated separator layer at the interface by re-solvating binders included in the first integrated separator layer and the second integrated separator layer. By re-solvating the binders, the solvated binders may be induced to function as an adhesive at the separator interface, adhering both constituent inorganic particles of the respective first and second integrated separator layers to each other and adhering the first inorganic particles of the first integrated separator layer to the second inorganic particles of the second integrated separator layer. Furthermore, increasing a plasticity at the interface may cause the first plurality of inorganic particles and the second plurality of inorganic particles to move relative to each other, thereby increasing a surface area of the separator interface.

In some examples, applying a plasticizing solvent to the separator interface increases a flexibility of composite materials forming the first integrated separator and/or the second integrated separator layer, facilitating integration and/or interpenetration between the first integrated separator layer and/or the second integrated separator layer, thereby forming a single separator layer. Accordingly, in some examples, applying the plasticizing solvent may be performed after drying and/or calendering of the first and/or the second electrode. Accordingly, binders of dried integrated separator layers may be solvated by the plasticizing solvent, facilitating movement of previously immobilized separator particles, and the integration of the first and second integrated separator layers. In some examples, the plasticizing solvent comprises any suitable substance configured to increase the plasticity of a separator composite, such as an electrolyte, N-Methyl pyrrolidone (NMP), cyclic carbonates, esters, ethers, monomeric solvents, polymeric solvents, and/or the like.

In some examples, applying the plasticizing solvent to the separator interface between the first integrated separator layer and the second integrated separator layer comprises applying the plasticizing solvent to the first integrated separator layer, the second integrated separator layer, and/or the first integrated separator layer utilizing any suitable method, such as spraying, coating, misting, and/or the like. In some examples, applying the plasticizing solvent to the separator interface between the first integrated separator layer and the second integrated separator layer comprises applying a slurry forming a third integrated separator layer to surfaces of the first and/or the second integrated separator layer. In some examples, the slurry forming the third integrated separator layer is configured to have a higher binder concentration than the first integrated separator layer and/or the second integrated separator layer. In some examples, the third integrated separator layer is configured to have a porosity within 20% of the first integrated separator layer and the second integrated separator layer.

In some examples, step 2208 comprises selectively applying the plasticizing solvent at selected regions of the interface, such as at regions adjacent to tabs of the cathode. In some examples, step 2208 comprises applying an electrolyte to a packaged cell, thereby causing binders within the cell to swell and soften, leaving residual solvent to function as a plasticizing agent at the interface. In some examples, step 2208 comprises applying excess electrolyte to a packaged cell, such that excess electrolyte within the packaged cell plasticizes binders included in the first integrated separator layer and the second integrated separator layer, forming, the single separator layer. In some examples, insulating the tab of the cathode comprises applying a plasticizing solvent to the separator interface in regions of the first integrated separator layer and/or the second integrated separator layer adjacent to the tab of the cathode.

In some examples, applying the plasticizing solvent to the separator interface lowers a glass transition temperature of binders within the first integrated separator layer and the second integrated separator layer. Accordingly, subsequently calendering the cell, such as in step 2110, causes the binders to fuse together at a lower temperature that would otherwise be required.

In some examples, bonding the first integrated separator layer to the second integrated separator layer comprises polymerizing binders disposed at a separator interface between the first integrated separator layer and the second integrated separator layer. In some examples, bonding the first integrated separator layer to the second integrated separator layer comprises applying a polymerizing agent at the separator interface. In some examples, bonding the first integrated separator layer to the second integrated separator layer comprises applying heat to the separator interface, thereby activating polymerizing agents disposed within the first integrated separator layer and the second integrated separator layer. In some examples, the binder comprises any suitable material or mixture of materials which forms a crosslinked matrix upon calendering, such as poly(vinyl alcohol)/poly(acrylic acid) (PVA-PAA) (esterification crosslinking), carboxymethyl cellulose/poly(acrylic acid) (CMC-PAA) (esterification crosslinking), carboxymethyl cellulose/polyethylene glycol (CMC-PEG) (epoxide crosslinking), poly(vinyl pyrollidine) crosslinking, and/or the like. Accordingly, upon application of heat and pressure during the calendering process, the binders in the adjacent first integrated separator layer and the second integrated separator layer crosslink, irreversibly binding the layers and forming the unified separator layer.

In some examples, bonding the first integrated separator layer to the second integrated separator layer comprises applying an activating substance to the interface, thereby activating polymerizing agents disposed within the first integrated separator layer and the second integrated separator layer. In some examples, the activating substance comprises a polymerization initiator, such as an azo initiator, a peroxide initiator, and/or the like. In some examples, the activating substance comprises a pH-mediating substance, such as oxalic acid, boronic acid, and/or the like. In some examples, the activating substance comprises a plasticizing solvent, such as an electrolyte, N-Methyl pyrrolidone (NMP), cyclic carbonates, esters, ethers, monomeric solvents, polymeric solvents, and/or the like. In some examples, bonding the first integrated separator layer to the second integrated separator layer comprises applying oligomers and/or monomers to the separator interface, such as ethylene, vinyl chloride, propylene, esters, and/or the like. Accordingly, in some examples, bonding the first integrated separator layer to the second integrated separator layer comprises spraying a cyclic ether onto the separator interface. In some examples, bonding the first integrated separator layer to the second integrated separator layer comprises applying 0.1 mm polymer nitrate onto the separator interface.

In some examples, bonding the first integrated separator layer to the second integrated separator layer comprises controlling a degree of crosslinking at the separator interface and within remaining portions of the first integrated separator layer and the second integrated separator layer, facilitating a desired porosity profile at different regions of the single separator layer. For example, increasing crosslinking within the separator layer may increase a tortuosity of the separator layer. Accordingly, polymerizing binders included in the first integrated separator layer and the second integrated separator layer may facilitate ion transport through the separator, facilitating increased cohesion at the separator layer without decreasing a charge and/or discharge speed of the electrochemical cell. Systems and methods according to the present disclosure provide a tailored crosslinking and/or porosity profile inducing increased polymerization at the separator interface to increase adhesion. In some examples, oligomers and/or monomers may be included throughout the first integrated separator and the second integrated separator, while the activating substance is applied only at the separator interface. In some examples, oligomers and/or monomers are applied only at the separator interface, facilitating increased cross-linking at the interface when compared with other regions of the first integrated separator and the second integrated separator. In some examples, applying oligomers and/or monomers to the separator interface comprises a slurry forming a third integrated separator layer to surfaces of the first and/or the second integrated separator layer, wherein the slurry comprises the oligomers and/or monomers. In some examples, polymerization within the first integrated separator layer and/or the second integrated separator layer is configured to insulate the tab of the cathode. Accordingly, in some examples, oligomers and/or monomers are applied to regions of the separator interface adjacent the tab of the cathode. In these examples, the oligomers and/or monomers may be included in a slurry forming a cathode integrated separator (i.e., either the first integrated separator or the second integrated separator). Accordingly, when polymerization is induced, the cathode integrated separator crosslinks to a greater degree than the anode integrated separator.

In some examples, oligomers and/or monomers included in the first integrated separator and/or the second integrated separator are configured to crosslink upon application of a first activation method, and oligomers and/or monomers included at the separator interface are configured to crosslink upon application of a second activation method. Accordingly, oligomers and/or monomers may be incorporated into a slurry forming the first integrated separator and/or the second integrated separator. For example, binders included in the first integrated separator and/or the second integrated separator may be configured to crosslink upon application of heat. However, oligomers and/or monomers incorporated into the slurry may be configured to crosslink upon application of a plasticizing solvent, the application of a higher temperature than that previously applied, the application of an electrolyte, and/or the like. In some examples, polymerization within the first integrated separator and/or the second integrated separator is induced during a drying and/or calendering process, and bonding at the separator interface is induced by heating the previously-formed polymers almost to their melting point, such as by laminating the electrochemical cell, thereby bonding the polymer molecules to each other. In some examples, the first integrated separator layer and/or the second integrated separator layer are configured to induce polymerization upon contact. In these examples, one of the first integrated separator layer and the second integrated separator layer includes oligomers and/or monomers and the other one of the first integrated separator layer includes an activating substance configured to initiate polymerization. Upon stacking of the first electrode and the second electrode, polymerization is induced at the separator interface. In some examples, the activating substance comprises a polymeric initiator such as an azo initiator, a peroxide initiator, and/or the like. In some examples, the activating substance comprises a pH-mediating substance such as oxalic acid, boronic acid, and/or the like.

Step 2110 of method 2100 includes calendering or compressing a stacked cell including the anode and the cathode. In some examples, method 2100 is configured for use in manufacturing a wound cell. In some examples, step 2110 of method 2100 includes simultaneously pressing, calendering, and laminating the electrodes as a unit. Accordingly, the electrode stack utilized in the wound cell includes a single anode and a single cathode, which are collectively rolled into a canister. Calendering or compressing the cell may include calendering the cell using a roller, as shown in FIG. 14, calendering the cell using a pair of rollers, applying pressure using a press, and/or any suitable method for applying a compressive force on the entire cell stack. In some examples, calendering or compressing the cell may include utilizing a rolling heat press and/or a linear heat press to laminate one or more electrodes within the electrochemical cell, forming a cell stack. In some examples, calendering or compressing the cell includes calendering the cell and applying high-energy radiation, such as ultraviolet (UV), gamma radiation, and/or the like to irreversibly or reversibly cross-link binders within the first integrated separator and/or the second integrated separator, chemically bonding the integrated separator layers together and forming the unified separator.

In some examples, calendering the cell is performed by cell calendering system 2250, which may comprise any suitable system, such as a pair of rollers, a press, and/or the like. This may facilitate a desired level of densification of the cell stack, improving overall impedance of the electrochemical device while improving manufacturing speed, ease, and yield. Compressing a cell stack including directly adjacent ceramic separator layers may cause the layers to become indistinguishable, further improving cell impedance. This compressive force applied to the entire cell stack may additionally cause adjacent integrated separator layers included in the anode and the cathode to merge and become indistinguishable, further reducing cell impedance by eliminating particle pulverization found at interfaces between the separator layers. In some examples, calendering the cell activates an adhesive applied to the first integrated separator layer and/or the second integrated separator layer at step 2106, adhering the integrated separator layers to each other.

In some examples, calendering the cell causes polymers, such as binders, included within the cell to fuse to each other. In some examples, this causes binders within adjacent separator layers to fuse together, forming a single unified separator layer disposed between the first electrode and the second electrode. In some examples, calendering the cell comprises heating the polymer above a glass transition temperature of the polymer.

Step 2112 of method 2100 includes optionally packaging the electrochemical cell. Packaging the electrochemical cell may include inserting the cell into a can, as with a wound cell, inserting the cell into a pouch bag, as with a pouch cell, and/or any other suitable method of packaging an electrochemical cell such as a lithium-ion battery.

### G. Illustrative Combinations and Additional Examples

This section describes additional aspects and features of electrochemical cells having integrated separators, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. An electrode comprising:
a first active material layer comprising a first plurality of active material particles adhered together by a first binder; and
a first integrated separator layer layered onto and directly contacting the first active material layer, wherein the first integrated separator layer comprises a first plurality of nitride particles mixed with a first plurality of ceramic disruptor particles and adhered together by a second binder.

A1. The electrode of paragraph A0, wherein the first plurality of nitride particles comprise hexagonal-boron nitride.

A2. The electrode of paragraph A0 or A1, wherein the first plurality of ceramic disruptor particles comprise alumina.

A3. The electrode of any of paragraphs A0 through A2, wherein a volumetric ratio between the first plurality of nitride particles and the first plurality of ceramic disruptor particles is from 3.5:1 to 4.3:1.

A3.1. The electrode of any of paragraphs A0 through A2, wherein the first integrated separator layer includes from 65% to 70% hexagonal-boron nitride by weight.

A3.2. The electrode of any of paragraphs A0 through A2, wherein the first integrated separator layer includes from 77% to 82% hexagonal-boron nitride by volume.

A4. The electrode of any of paragraphs A0 through A3.2, wherein the first plurality of nitride particles are substantially platelet-shaped.

A5. The electrode of any of paragraphs A0 through A4, wherein the first integrated separator layer includes up to 99% ceramic disruptor particles by volume.

A6. The electrode of any of paragraphs A0 through A5, wherein the first integrated separator layer has a thickness from 5 μm to 23 μm.

A6.1. The electrode of any of paragraphs A0 through A5, wherein the first integrated separator layer has a thickness from 3 μm to 16 μm.

A6.2 The electrode of any of paragraphs A0 through A5, wherein the first integrated separator layer has a thickness from 1 μm to 30 μm.

A7. The electrode of any of paragraphs A0 through A6.1, wherein the first integrated separator layer has a porosity from 20% to 95%.

A8. The electrode of any of paragraphs A0 through A7, further comprising an interlocking region coupling the first active material layer to the first integrated separator layer.

A9. The electrode of any of paragraphs A0 through A8, wherein the first active material layer is layered onto and directly contacting a current collector.

A10. The electrode of any of paragraphs A0 through A9, further comprising a second active material layer directly contacting the first active material layer.

A11. An electrochemical cell comprising the electrode of any of paragraphs A0 through A10.

A12. A method of manufacturing the electrode of any of paragraphs A0 through A10.

B0. A method of manufacturing a cathode, the method comprising:
punching a cathode from a substrate, the cathode comprising a cathode body and a cathode tab extending from the cathode body;
applying a protective strip to a junction between the cathode tab and the cathode body.

B1. The method of paragraph B0, further comprising stacking the cathode with at least one anode to form an electrode stack.

B2. The method of paragraph B1, further comprising calendering the electrode stack.

B3. The method of any of paragraphs B0 through B2, wherein the protective strip comprises a polymer, such as polypropylene, polyethylene, polyimine, and/or polyethylene terephthalate.

B4. The method of any of paragraphs B0 through B2, wherein the protective strip comprises a wax, such as paraffin, polyethylene, Fischer Tropsch, and/or stearic acid.

B5. The method of any of paragraphs B0 through B4, wherein applying the protective strip comprises extruding the protective strip onto the junction.

B6. The method of any of paragraphs B0 through B4, wherein applying the protective strip comprises laminating the protective strip onto the junction.

B7. The method of any of paragraphs B0 through B6, wherein the protective strip is applied to the junction between the cathode tab and the cathode body before the cathode is punched from the substrate.

B8. The method of paragraph B7, wherein the protective strip is applied as a bead of slurry material.

B9. The method of paragraph B7 or B8, wherein the protective strip is deposited substantially simultaneously with one or more electrode layers forming the cathode body.

C0. A cathode comprising:
a current collector defining an electrode body and a tab extending from the electrode body;
a cathode composite layered onto the electrode body; and
a protective strip applied to a junction between the electrode body and the tab.

C1. The cathode of paragraph C0, wherein the protective strip comprises a polymer, such as polypropylene, polyethylene, polyimine, and/or polyethylene terephthalate.

C2. The cathode of paragraph C0, wherein the protective strip comprises a wax, such as paraffin, polyethylene, Fischer Tropsch, and/or stearic acid.

D0. A method of manufacturing an electrochemical cell, the method comprising:
manufacturing a first electrode, wherein manufacturing the first electrode includes:
   layering a first active material layer onto a first current collector substrate, the first active material layer including a plurality of first active material particles; and
   layering a first integrated separator layer onto the first active material layer, the first integrated separator layer including a plurality of first ceramic separator particles; and
manufacturing a second electrode, wherein manufacturing the second electrode includes:
   layering a second active material layer onto a second current collector substrate, the second active material layer including a plurality of second active material particles; and
   layering a second integrated separator layer onto the second active material layer, the second integrated separator layer including a plurality of second ceramic separator particles; and
   placing the first electrode onto the second electrode such that the first integrated separator layer is adjacent to the second integrated separator layer.

D1. The method of paragraph D0, further comprising calendering the first electrode.

D2. The method of paragraph D0 or D1, further comprising calendering the second electrode.

D3. The method of any of paragraphs D0 or D1, further comprising applying an adhesive to the first integrated separator layer, the second integrated separator layer, and/or both.

D4. The method of any of paragraphs D0 through D3, further comprising calendering the electrochemical cell such that the first integrated separator layer and the second integrated separator layer merge and become indistinguishable from each other.

D4.1. The method of paragraph D4, wherein calendering the electrochemical cell comprises utilizing a heat press to laminate the electrochemical cell such that the first integrated separator layer and the second integrated separator layer merge and become indistinguishable from each other.

D4.2. The method of paragraph D4, wherein calendering the electrochemical cell further comprises applying ultraviolet radiation to the electrochemical cell.

D5. The method of any of paragraphs D0 through D4, further comprising bonding the first integrated separator layer to the second integrated separator layer, thereby forming a single unified separator layer.

D5.1. The method of paragraph D5, wherein bonding the first integrated separator layer to the second integrated separator layer comprises applying a plasticizing solvent to a separator interface between the first integrated separator layer and the second integrated separator layer.

D5.1.1. The method of paragraph D5.1, wherein applying the plasticizing solvent is performed after drying the first electrode and the second electrode.

D5.1.2. The method of paragraph D5 or D5.1, wherein the plasticizing solvent comprises N-Methyl pyrrolidone.

D5.1.3. The method of paragraph D5 or D5.1, wherein the plasticizing solvent comprises a cyclic carbonate.

D5.1.4. The method of any of paragraphs D5 through D5.1.3, wherein the second electrode is a cathode, and wherein applying the plasticizing solvent comprises selectively applying the plasticizing solvent to the second integrated separator layer.

D5.1.5. The method of any of paragraphs D5 through D5.1.4, further comprising packaging the electrochemical cell; and wherein applying the plasticizing solvent comprises applying the plasticizing solvent to the packaged electrochemical cell.

D5.2. The method of any of paragraphs D5 through D5.1.4, wherein bonding the first integrated separator layer to the second integrated separator layer comprises polymerizing binders disposed at a separator interface between the first integrated separator layer and the second integrated separator layer.

D5.2.1. The method of paragraph D5.2, wherein polymerizing binders disposed at a separator interface between the first integrated separator layer and the second integrated separator layer comprises applying a polymerization initiator to the separator interface.

D5.2.2. The method of paragraph D5.2.1, wherein the polymerization initiator comprises a peroxide initiator.

D5.3. The method of any of paragraphs D0 through D2.2, wherein bonding the first integrated separator layer to the second integrated separator layer comprises polymerizing monomers disposed at a separator interface between the first integrated separator layer and the second integrated separator layer.

D5.3.1. The method of paragraph D5.3, further comprising applying monomers to a surface of the first integrated separator layer and/or the second integrated separator layer.

D5.3.2. The method of paragraph D5.3 or D5.3.1, wherein the first integrated separator layer comprises a polymeric initiator and wherein the second integrated separator layer comprises a polymer configured to polymerize upon contact with the polymeric initiator, such that polymerization at the separator interface is initiated by contact between the first integrated separator layer and the second integrated separator layer.

### Advantages, Features, and Benefits

The different embodiments and examples of the electrodes described herein provide several advantages over known electrodes including integrated separators and methods of manufacturing electrodes including integrated separators. For example, illustrative embodiments and examples described herein provide an integrated separator with increased thermal conductivity, facilitating cooling of the cell during use.

Additionally, and among other benefits, illustrative embodiments and examples described herein improve ion transport through an integrated separator by mixing hexagonal-boron nitride with aluminum oxide, thereby creating disorder, increasing porosity, reducing tortuosity, and facilitating an ideal porosity.

Additionally, and among other benefits, illustrative embodiments and examples described herein decrease the operating temperature of an electrochemical cell including integrated separators in accordance with the present disclosure.

Additionally, and among other benefits, illustrative embodiments and examples described herein prevent shorting between cathodes and anodes due to burrs caused by punching of electrodes.

Additionally, and among other benefits, illustrative embodiments and examples described herein facilitate streamlined manufacturing of wound cells including integrated separators.

Additionally, and among other benefits, illustrative embodiments and examples described herein facilitate ion transport through the separator, facilitating increased cohesion at the separator layer without decreasing a charge and/or discharge speed of the electrochemical cell.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A method of manufacturing an electrochemical cell, the method comprising:
manufacturing a first electrode, wherein manufacturing the first electrode includes:
layering a first active material layer onto a first current collector substrate, the first active material layer including a plurality of first active material particles; and
layering a first integrated separator layer onto the first active material layer, the first integrated separator layer including a plurality of first ceramic separator particles; and
manufacturing a second electrode, wherein manufacturing the second electrode includes:
layering a second active material layer onto a second current collector substrate, the second active material layer including a plurality of second active material particles; and
layering a second integrated separator layer onto the second active material layer, the second integrated separator layer including a plurality of second ceramic separator particles; and
placing the first electrode onto the second electrode such that the first integrated separator layer is adjacent to the second integrated separator layer.

2. The method of claim 1, further comprising calendering the first electrode.

3. The method of claim 1, further comprising applying an adhesive to the first integrated separator layer.

4. The method of claim 1, further comprising calendering the electrochemical cell such that the first integrated separator layer and the second integrated separator layer merge and become indistinguishable from each other.

5. The method of claim 4, wherein calendering the electrochemical cell comprises utilizing a heat press to laminate the electrochemical cell such that the first integrated separator layer and the second integrated separator layer merge and become indistinguishable from each other.

6. The method of claim 1, further comprising bonding the first integrated separator layer to the second integrated separator layer, thereby forming a single unified separator layer.

7. The method of claim 6, wherein bonding the first integrated separator layer to the second integrated separator layer comprises applying a plasticizing solvent to a separator interface between the first integrated separator layer and the second integrated separator layer.

8. The method of claim 7, further comprising applying heat and pressure to the separator interface after the plasticizing solvent has been applied.

9. The method of claim 7, wherein the plasticizing solvent comprises a cyclic carbonate.

10. A method of manufacturing an electrochemical cell, the method comprising:
placing a first electrode including a first integrated separator layer onto a second electrode including a second integrated separator layer, such that the first integrated separator layer is adjacent to the second integrated separator layer; and
calendering the first electrode and the second electrode as a cell stack, thereby causing the first integrated separator and the second integrated separator to merge and become indistinguishable from each other.

11. The method of manufacturing of claim 10, further comprising applying an adhesive to the first integrated separator layer.

12. The method of claim 11, wherein calendering the first electrode and the second electrode as a cell stack activates the adhesive, adhering the first integrated separator layer to the second integrated separator layer.

13. The method of claim 10, wherein calendering the electrochemical cell comprises utilizing a heat press to laminate the electrochemical cell.

14. The method of claim 10, further comprising applying a plasticizing solvent to a separator interface between the first integrated separator layer and the second integrated separator layer.

15. The method of claim 14, further comprising calendering the first electrode and the second electrode as a cell stack after application of the plasticizing solvent.

16. The method of claim 14, wherein the second electrode is a cathode, and wherein applying the plasticizing solvent comprises selectively applying the plasticizing solvent to the second integrated separator layer.

17. The method of claim 10, further comprising polymerizing binders disposed at a separator interface between the first integrated separator layer and the second integrated separator layer.

18. The method of claim 17, wherein polymerizing binders disposed at a separator interface between the first integrated separator layer and the second integrated separator layer comprises applying a polymerization initiator to the separator interface.

19. The method of claim 17, further comprising applying monomers to a surface of the first integrated separator layer.

20. The method of claim 17, wherein the first integrated separator layer comprises a polymeric initiator and wherein the second integrated separator layer comprises a polymer configured to polymerize upon contact with the polymeric initiator, such that polymerization at the separator interface is initiated by contact between the first integrated separator layer and the second integrated separator layer.
